(19) United States
(12) Patent Application Publication
(10) Pub. No.: US 2013/0031181 A1
(43) Pub. Date: Jan. 31, 2013

(54) Using Social Network Information And Transaction Information

(71) Applicants: George Eberstadt, New York, NY (US); Eric Pederson, New York, NY (US)

(72) Inventors: George Eberstadt, New York, NY (US); Eric Pederson, New York, NY (US)

(73) Assignee: TURNTO NETWORKS, INC., New York, NY (US)

(21) Appl. No.: 13/644,047

(22) Filed: Oct. 3, 2012

Related U.S. Application Data
(63) Continuation of application No. 12/098,618, filed on Apr. 7, 2008.
Application No. 12/098,618 is a continuation-in-part of application No. 12/026,972, filed on Feb. 6, 2008, now abandoned.
Application No. 12/026,972 is a continuation-in-part of application No. 11/968,431, filed on Jan. 2, 2008.

(51) Int. Cl. G06F 15/16

(52) U.S. Cl. 709/204

(57) ABSTRACT

Among other things, a user can determine, from aggregated transaction data, private information about a transaction of another party. The other party is associated, in a shared social network database, as a contact with the user. The activity of the other party is related to an activity or contemplated activity of the user. The private information is from a source that is controlled independently of the shared social network database and the aggregated transaction data.

The application is a continuation-in-part of U.S. patent application Ser. No. 12/026,972, filed Feb. 6, 2008, which is a continuation in part of U.S. patent application Ser. No. 11/968,431, filed Jan. 2, 2008, both incorporated here by reference in their entirety.

### BACKGROUND

This description relates to using social network (SN) information and transaction information.

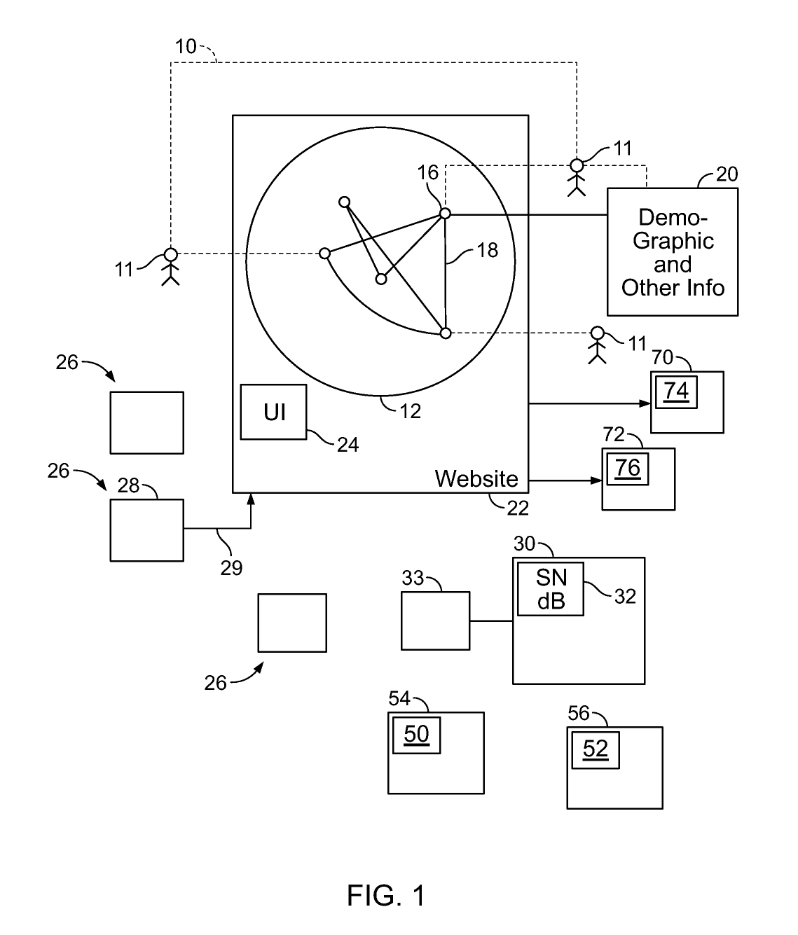

SN information includes, for example, information about connections between people and demographic and other information about the people who are the subject of the connections. As shown in FIG. 1, information about real life connections 10 among people 11 may be stored in a database 12 (also called a who-knows-whom database, a SN graph, or a SN database) in which each person 11 (and the demographic and other information 20 about the person) can be represented in a node 16 and the connections among people can be represented by connections 18 that join nodes.

SN databases such as database 12 are created and maintained as a core asset of SN sites 22, for example, Facebook or LinkedIn. The node information and the connection information of the database can be derived directly from the users of a SN site through a user interface 24 of the site (for example, when the user first registers or adds information later) or may be inferred from actions of users on the site, or may be obtained from other sources 26. For example, a separate site 28 that sells shoes may provide to the host of a SN site a list 29 of products purchased by people who are users of the SN site. The SN site may then, for example, display this information in association with other information about a “target” user, when an interested user of the SN site is viewing information about the target user. For example, if Bill is viewing Carol's profile on Facebook, he could be presented with a list of products that Carol has recently bought.

Although a site 30 may have a primary function other than maintaining a SN, such as retail sales, the site also may generate and maintain a proprietary SN database 32 about its customers 33. The proprietary SN database may include node information and connection information that is derived explicitly or implicitly from the customers as they register as users of the site, maintain their user profiles on the site, and use the site 30 for its main purpose. Such a site may use the proprietary SN database to enhance the experience of its users and improve the sales or other performance of the site.

Users who want to participate in the proprietary SN databases 50, 52 of multiple sites 54, 56 may register separately for each of them by providing demographic and personal information and defining connections they have with other people who are users of the site. To complete the creation of the connections for each of the proprietary SN databases, the other people whom they have identified are asked to verify and consent to the inclusion of the connection information in the database.

A SN site may make its SN database available to other parties 70, 72 who may develop applications 74, 76 to use the SN information. These applications are installed by the users on both sides of a connection defined by the SN database in order for the SN aspects of the applications to be usable.

### SUMMARY

In general, in an aspect, a user can determine,

from aggregated transaction data, private information about a transaction of another party. The other party is associated, in a shared social network database, as a contact with the user. The activity of the other party is related to an activity of the user. The private information originates from a source that is controlled independently of the stored shared social network database and the aggregated transaction data.

Implementations may include one or more of the following features. The user determines the private information by an online search of the aggregated transaction data. The user determines the private information by navigating pre-defined categories of transaction data. The stored shared social network database and the aggregated transaction data are under common control. The aggregated transaction data includes information from sources that are controlled independently of one another. The activity comprises a purchase of an item of commerce. The user can determine the private information from a facility that is controlled independently of the source and independently of the shared social network database. The facility obtains the information by searching the aggregated transaction data. The searching is done automatically in connection with a search being performed by the user at the facility. The private information includes the identity of the source of the private information. The private information is required to include the identity of the source of the private information. The private information is required not to include the identity of the source of the private information.

In general, in an aspect, an online comparison facility, that provides comparative information about items of commerce, can give a user access to information about transactions that are related to the items and that were engaged in by social network contacts of the user on at least one online transaction facility, the transaction facility being controlled independently of the online comparison facility.

Implementations may include one or more of the following features. The online comparison facility obtains the information about transactions related to the items of commerce from a shared body of aggregated transaction data that has been acquired from the online transaction facility. The online comparison facility comprises a website. The online transaction facility comprises a website. The online transaction facility comprises a retail merchant. There are two or more transaction facilities that are controlled independently of each other and independently of the online comparison facility.

In general, in an aspect, for private information about a transaction conducted by a user at an online transaction facility, a supplier of the private information can control access to the private information, at another online facility, by a party who is a social network contact of the user.

Implementations may include one or more of the following features. The private information includes the identity of the user who conducted the transaction. The private information includes the identity of the online transaction facility. The transaction was a purchase of an item of commerce. The supplier of the private information that controls access is the online transaction facility at which the transaction was conducted. The supplier of the private information that controls access is a host of aggregated transaction data accumulated from the facility at which the transaction was conducted and other transaction facilities. The supplier of the private information that is enabled to control access is the user who conducted the transaction. The access is controlled by requiring the identity of the transaction facility to be included when the information is accessed. The access is controlled by preventing the identity of the transaction facility to be included when the information is accessed. The access is controlled based on preferences of the transaction facility.

In general, in an aspect, private information about a transaction conducted by a user at an online transaction facility, is made available to other facilities for dissemination to social network contacts of the user, automatically upon the occurrence of a condition. The user can override the condition and prevent the information from being made available to the other facilities for dissemination.

Implementations may include one or more of the following features. The transaction is a purchase of an item of commerce. The condition is a passage of a time period. The user is given electronic notice of the transaction and the condition before the condition occurs.

Other aspects and features, and combinations of them, may be expressed as methods, systems, apparatus, means for performing functions, program products, and in other ways.

Other aspects and features will become apparent from the following description and from the claims.

### DESCRIPTION

FIGS. 1 through 3, 24, 28, and 30 are block diagrams.

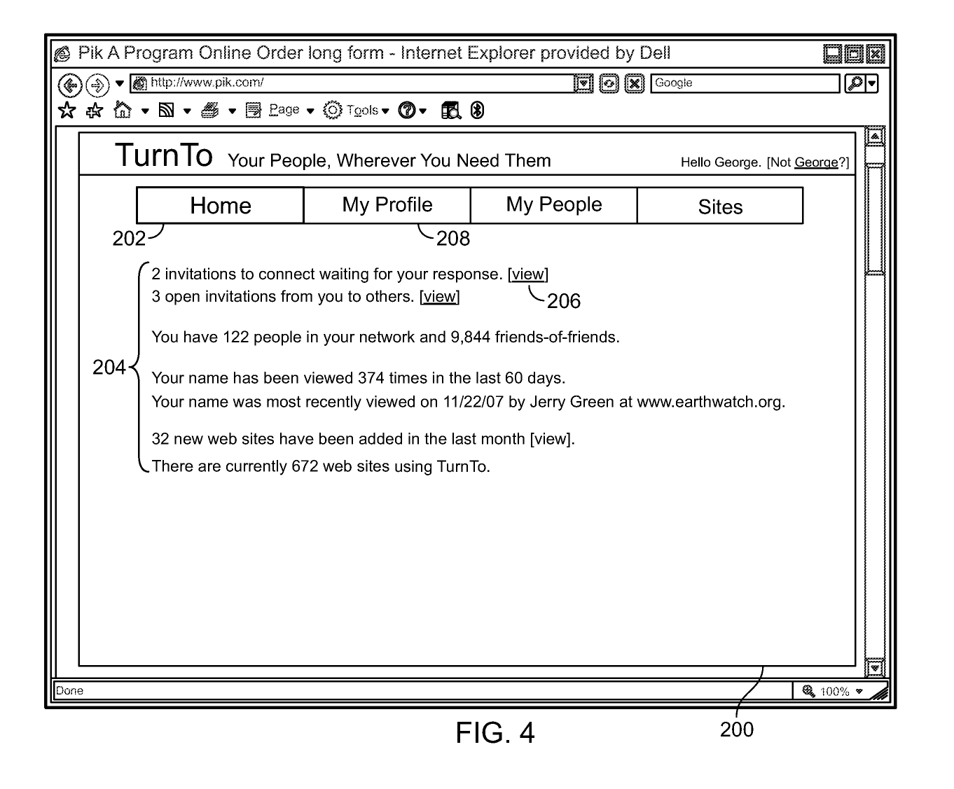

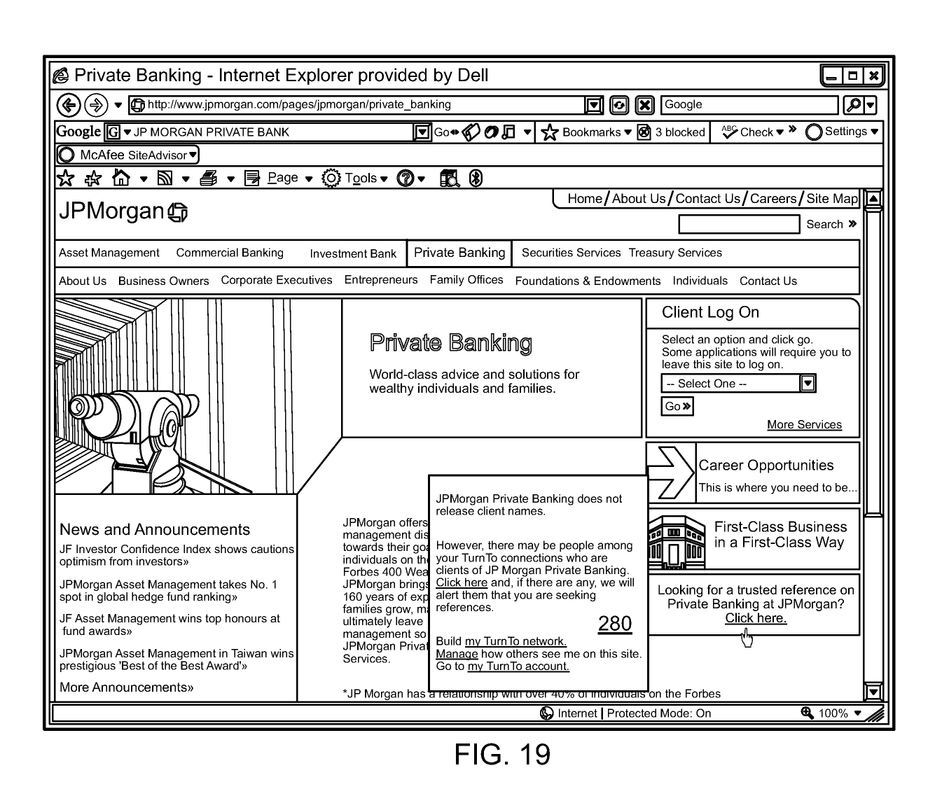

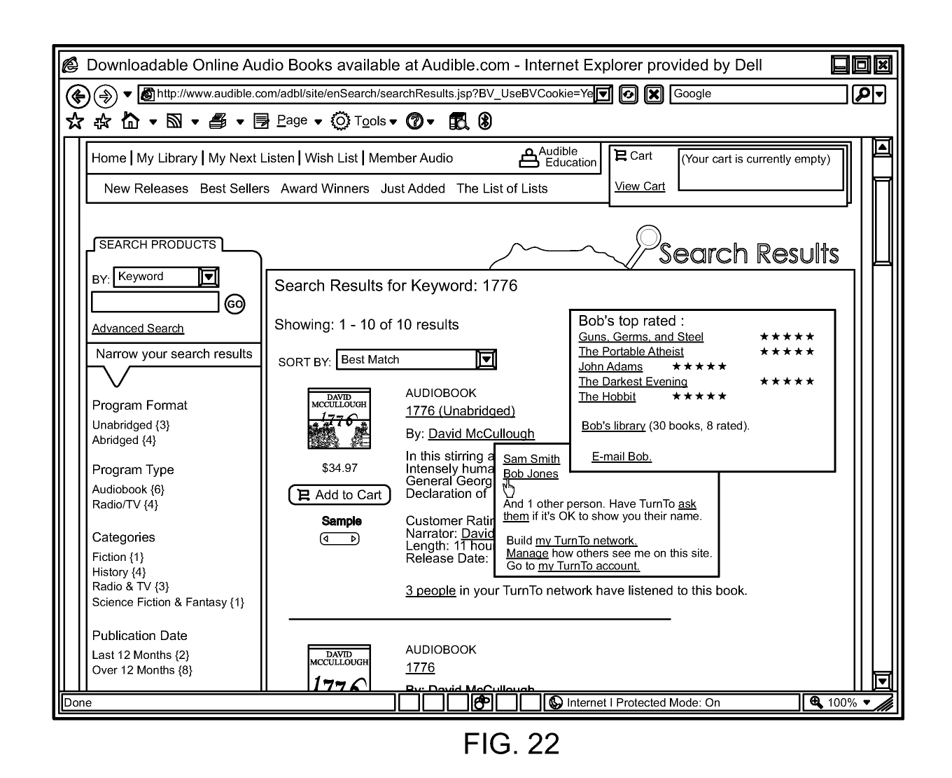

FIGS. 4 through 23, 25 through 27, and 29 are screen shots.

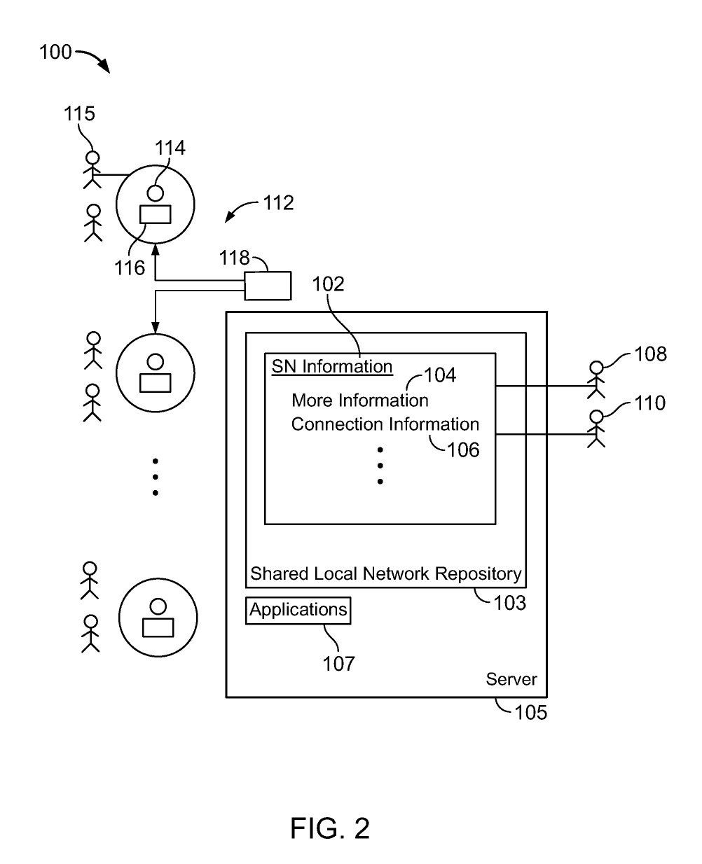

As shown in FIG. 2, a shared SN system 100 may, among other things, receive, create, aggregate, supplement, organize, maintain, use, make accessible, and distribute SN information 102 in a shared SN repository 103. The shared information includes, among other things, node information 104 and connection information 106 about users 108, 110. Users of the shared SN system 100 and users of a wide variety (and potentially a very large number) of other sites 112 (e.g., sites that have subscribed to services provided by or have otherwise become affiliates of the shared system 100) are able to submit, maintain, update, release, and provide permissions, authorizations, and other controls at a single shared SN repository.

Users of the shared SN system 100 and of sites 112 may then use proprietary or open features and applications that are running at each of the sites or combinations of them and that are designed to rely on and take advantage of the SN information of the users (and information about the users and others stored in the shared SN repository and at other sites 112 that have subscribed to or made other arrangements to use and/or contribute to all or part of the shared SN repository). The features and applications of the sites 112 may be ones that the users already use (for example, retail sites, portals, SN sites, and others), or ones that the users begin to use after having become users of the shared SN system 100.

We use the term sites extremely broadly to include any on-line or non-online capability, service, facility, resource, feature, or application that can make use of the SN information stored in the shared repository 103 in any way. Many examples of such sites operate using content of a wide variety of kinds Sites include websites of all different types, including portals, commercial sites, individual sites, internal sites of enterprises, and all of the types of content that they support, including applications, audio, video, images, catalogs, and accounts to name a few. Sites may be relatively static or relatively dynamic, such as publications, blogs, review sites, photo, video, and audio sites, user-generated content sites, location information, mapping sites, and other kinds of content sites, among others. Static sites can be of the kind typically used for business to business marketing collateral and non-retail transactional sites (e.g., B2B transactions and client relationships that may not be naturally characterized as a “transaction”). Chat facilities, groups, instant messaging, emailing, and other forms of content based communication fit within the concept of sites.

In general, sites enable users to engage in activities, which we use in its broadest sense. Activities may include, for example, money-based transactions such as retail, wholesale, and business sales activities, investments, and financial instruments, and also non-money-based activities such as bartering, exchanging of information, registration, submission of content, borrowing, lending, and any other kind of exchange or passing of content or value from one party to another or among multiple parties, to name a few. Activities need not involve a bargain or exchange but could also involve, for example, an activity of a user with respect to content that may be available at the site. This could include submitting, updating, modifying, or removing content; searching, sorting, downloading, displaying, presenting, or retrieving content; participating in a group activity as an observer, a player, a critic, or a recipient; registering, signing in, accepting, withdrawing, or terminating rights, participation, membership, or accounts. These are only examples and the term activity is used in an extremely broad sense.

Sites may be present at any location, for example, on servers, on personal work stations, on portable devices, and at other places. Access to sites may occur through any communication channel, such as wired or wireless channels using any kind of communication infrastructure such as the Internet, intranets, dial up communication, dedicated and private networks and the like.

The repository 103 can be part of a server 105 hosted by a party that serves as a clearinghouse, broker, or medium for shared SN and other information derived from many sources and made available to many sites. The server may host a wide variety of other applications 107 that enable it to perform the services and functions described here, and many others. Access to the shared repository and the applications in the server can be made through any communication channel of any kind, including, in some implementations, networks such as the Internet.

The shared SN repository 103 can be created and maintained “once” without duplication of effort and then used by many sites (and users of the shared system and of other sites) in many ways and at many times. Because the users need only register (and provide other SN information) in one place to have their SN information available (with permission) at a large number of sites, they are freed from the need to register and maintain their node information and connection information redundantly at many different sites. This feature significantly increases the chances that users will participate in the shared system. Because users are more likely to participate, the system 100 substantially increases the opportunities for independent sites to create applications that take advantage of the information contained in the shared repository with a reasonable expectation of participation by a large number of users.

As the size, extent, complexity, and completeness of the shared SN system grows, its value to other sites and to users grows.

Other sites 112 that wish to use SN information are able to access, and make a wide variety of uses of the shared SN repository or portions of it, available at a single, convenient location reducing or eliminating the need for the site operator to convince its users to build their social networks within the site. The sites 112 can be completely flexible in how they use the shared SN repository information to best suit their business model and functions and the expectations of their users. Sites can combine all or part of the shared SN repository information with their own user information 114 (for example, SN information about their users 115, and non-SN information related to their users) for use by their applications 116. An application development toolkit 118 can be provided to the facilities to simplify their development and integration of such applications.

A variety of business models can be used to finance the shared system 100 and to generate revenue from it. In some models, in order to build the shared SN repository to a significant size quickly, the database and tool kit may be provided to affiliated sites at no charge or a small charge for an initial period of time to encourage those sites to adopt applications that will make use of the shared SN system. Later, a monthly or annual license fee may be charged to the affiliated sites for continued access. A wide variety of revenue models can be used to define the license fees, including licenses based on volume of use, number of transactions, revenue associated with the use, time-based charges, and others. Sometimes we refer to sites that are making use of information in the shared SN repository as affiliates or affiliated sites of the shared SN repository. Affiliates can include sites, other online devices, applications, features, and other entities and enterprises. Typically an affiliate has access to information in the shared SN repository by virtue of an agreement, license, course of dealing, or other authorization.

Other sources of revenue in some business models can include, for example, license fees from advertisers for uses of the shared SN repository, and development by the operator of the shared SN repository of applications that leverage the repository to generate advertising or usage revenues.

It also may be possible to derive other revenue streams from the users of the system 100, for example, by providing premium services associated with the use of the shared SN system or by enabling access by paying users to facilities that are otherwise restricted.

As indicated by the discussion above and as will be apparent from the following description, important features of the shared system include (but are not limited to) the following:

1. The system serves as a builder, clearinghouse, intermediary, and broker for information in the shared SN repository. Other sites (and other parties, including advertisers, manufacturers, distributors, and financial institutions, for example) can make use of the information in the shared repository as the basis of valuable and useful applications and features. Users of the shared system agree in advance to permit information about them that is in the shared repository (and, in some cases, would otherwise be considered confidential) to be communicated from the system to the other sites. The other sites, which are typically controlled independently from the shared system) control the sharing of that information, consistent with permissions given by the users to whom the information belongs, with people with whom the users are connected (according to the connection information in the shared repository). We sometimes refer to people with whom a user is connected simply as the user's connections. The display of the information about the users of the shared SN repository, to users of the other sites is done through the other sites. Each site can store some or all of the information from the shared repository in its own repository 116, combine it in any way it considers useful with its own information about its own users and other users, and decide how, when, where, in what manner, and under what conditions to display the information to its users. Arrangements are made between applications running on the shared system and applications running on the other sites to assure compliance with the permissions, and to facilitate a potentially large number and wide range of other features between the shared system and the affiliate sites.

2. Information associated with people with whom a user has connections, according, for example, to the shared SN repository, can be displayed by (or the user can be given access in other ways to the information by or from) a site in connection with a transaction or any other activity in which the user of that site is engaging. Thus, the display of the information about the user's connection is not triggered merely when the user specifically indicates an interest in the information about the connection, or users having similar characteristics, or based on selected types of connections (for example, “show me all of the people with whom I have connections and who graduated from the same college as I”). Rather the display (or other giving of access) can be determined on the basis of, in the context of, and at the time when the user is working on a transaction or other activity. For example, if the user has added red wool pants to his shopping cart on the Lands End site, then in conjunction with that proposed purchase, and without further action by the user, information about his connections that may relate to the purchase (for example, his friends who have also bought pants from Lands End) are displayed to the initiating user.

We use the term display to refer broadly to any way in which the information can be exposed or presented to the user (or by which the user may be given any kind of access), for example, by display on a computer monitor, but also on any other device, or by presentation of sounds, video, images, text, applications, or any other content or manner of providing it. Display can also refer to making the information accessible to a user for pickup at another location, for searching, or for downloading in any manner, to name a few examples. Any manner in which the user is aware of the progress or nature of a transaction or activity (in the broadest sense) may be a form of “display”.

3. A user of the system 100 can control the character and level of his relationship with his connections in a complex and finely grained way for later control of how the information about him is used and displayed to others. The user is not limited merely to indicating that he and the other person are “connected” or “not connected”. For example, a user may specify that he knows another user and the other user is therefore a connection, yet the first user can control the extent to which (for example, the time, place, context, frequency, conditions, purpose, and other parameters for which) his information in the shared repository may be displayed (or otherwise made accessible) to the other user. For example, the user could set a permission requirement for his confidential information that would require “ask me” permission on a particular site or other facility before his information could be provided to any of his connections.

Based on this flexible permission arrangement, a user may be able to see, in connection with his use of a facility, things he has in common with people to whom he has a connection, such as when he has purchased (or is considering purchasing) the same item, has traveled to the same place, knows the same people, or is located near the other person. The applications running on the site could include, for example, ones that enable a person to play games and have contests with people with whom he has things in common, enable users to share information about themselves with their connections while restricting access by others; allow communications between two users to be shared exclusively with their connections (for example, “shouts” and “walls” and “endorsements” . . . ); and be used to permit third parties (e.g., sites, businesses) that have user information that would otherwise be considered private to share that information with a user's connections.

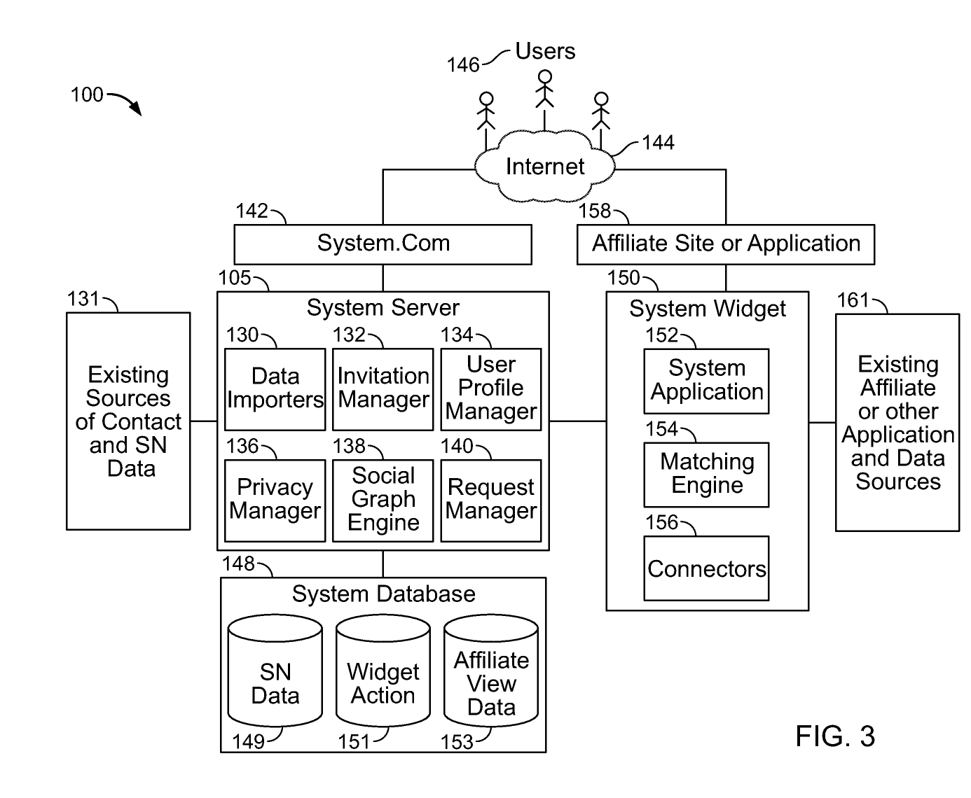

Another illustration of at least a portion of the shared system 100 is shown in FIG. 3. A system server 105 includes a number of functional modules. SN information importers 130 can import into the system environment SN information, including profile information, connection information, contacts and other information from a variety of sources 131, including the user's web mail accounts (e.g., Hotmail, Yahoo mail, Gmail, and others), a user's desktop mail system (e.g., Microsoft Outlook), SN sites where the user has an account (e.g., MySpace, Facebook, LinkedIn, and others), or other sources.

An invitation manager 132 keeps track of invitations to connect that a system member (we sometimes call a user who has registered with the shared system a member; we use the word “user” in a very broad sense not limited to a user who has registered, or a user who is a member) has extended to others and the invitations that are awaiting a response from the system member.

A user profile manager 134 keeps track of all attributes of a system member, including demographic information such as age, state and country, and gender, and identification information such as name, telephone number, and email address. A wide variety of attributes may be defined for this purpose and may include contact information, communication preferences, photos, various types of descriptors, and other information associated with a member.

A privacy preference manager 136 keeps track of the privacy (or authorization or permission) preferences that the user has expressed regarding other system members to whom he is connected or regarding use of his information by other sites and applications and features.

A social graph engine 138 tracks connections between system members and attributes that characterize those connections.

A report manager 140 generates reports from the information stored in the shared repository for audiences that may include system members, managers of affiliate sites and other sites, and system managers.

The services provided by the modules that run on the server are exposed through a System.Com site 142 that is accessible through the Internet 144 using a web browser located anywhere and permits users 146 to become members of the system, manage their system accounts, and manage the application functions that the system and its modules provide.

System members may choose to import their contacts, profiles, and SN connection information from other sites and applications where that information is already stored, such as the user's web mail accounts (e.g., Hotmail, Yahoo mail, Gmail, and others), the user's desktop mail system (e.g., Microsoft Outlook or others), SN sites where the user has an account (e.g., MySpace, Facebook, LinkedIn, and others), or other sources.

Shared SN system information is stored in, for example, a database 148. The information includes all information needed for the operation of the modules of the system server and other applications that may be added over time. The information includes, but is not limited to, connection information, profile information, user privacy and permission preferences, users' invitations to other users to connect with them (much of which can be stored in the SN data tables 149), log information on activities of the system server and applications (for example, when new members have joined, when connections between users have been made), log information 151 on the activity of the various system widgets (including display of system member names), and information about activities of system members 153 provided to the system by affiliate sites and applications.

The system widget 150 is application code that provides functionality to the affiliate sites using information and services provided by the system server and, in some cases, by the affiliate site or application or other sites or applications 161. The modules of the system widget include a system application 152 that exposes the functionality of the shared system to the user of the affiliate site or application or feature. The shared system can provide affiliates with application templates, which they may use in the form provided or may modify if required, to create applications. A matching engine 154 compares user IDs provided by the system server to user IDs provided by the affiliate application or site that is making use of the system application and returns matches to the system application, according to rules specified by the system application.

The system widget may provide connection facilities 156 to simplify the retrieval of information from the affiliate applications or sites from which information is to be obtained to support the functions of the system application. The affiliate site or application 158 is a site or application at which users may access the functionality of the system application (some functionality can be accessed by users directly through the System.com site).

The system widget may use information obtained from applications or sites of the affiliate or from other sources 161.

To take advantage of SN features on typical sites, each user must identify his SN connections by separate steps on each site. When the user signs up on another site, the user's SN connections must be re-identified to the new site. The repeated identification of SN connections can create a tangle of connections that sometimes may be incomplete or time consuming to re-identify.

Thus, considered at a higher level of abstraction, the shared SN system described here serves as an aggregation system for users' SN information, enabling them to maintain this information in a single place and to use features and applications that take advantage of the information at a large number of affiliate sites that subscribe to the shared SN system, including affiliate sites that the users already use.

An important feature of the shared system is the shared SN repository. This independent electronic database of SN relationships of a user can include the profiles of the system members, their connections to other system members, and their privacy (and permission) preferences with respect to their connections and to the affiliate sites. The database design can be structured to provide affiliate sites with the information they need to effectively tailor the social experiences they provide to the needs and expectations of their users while recognizing that different sites will need different types of information and also meeting the needs of system users for simplicity and speed.

### Shared System User Interface

As shown by way of one example in FIG. 4, the shared SN system can expose a simple, effective web-based user interface 200 through its own site to users. The interface provides the home page shown in FIG. 4 and pages for My Profile, My People, and Sites, accessible using buttons of a simple navigation bar 202. A series of status statements 204 reports on a variety aspects of the user's activities and connections and the status of the system. In some cases, links 206 enable the user to view more detailed information.

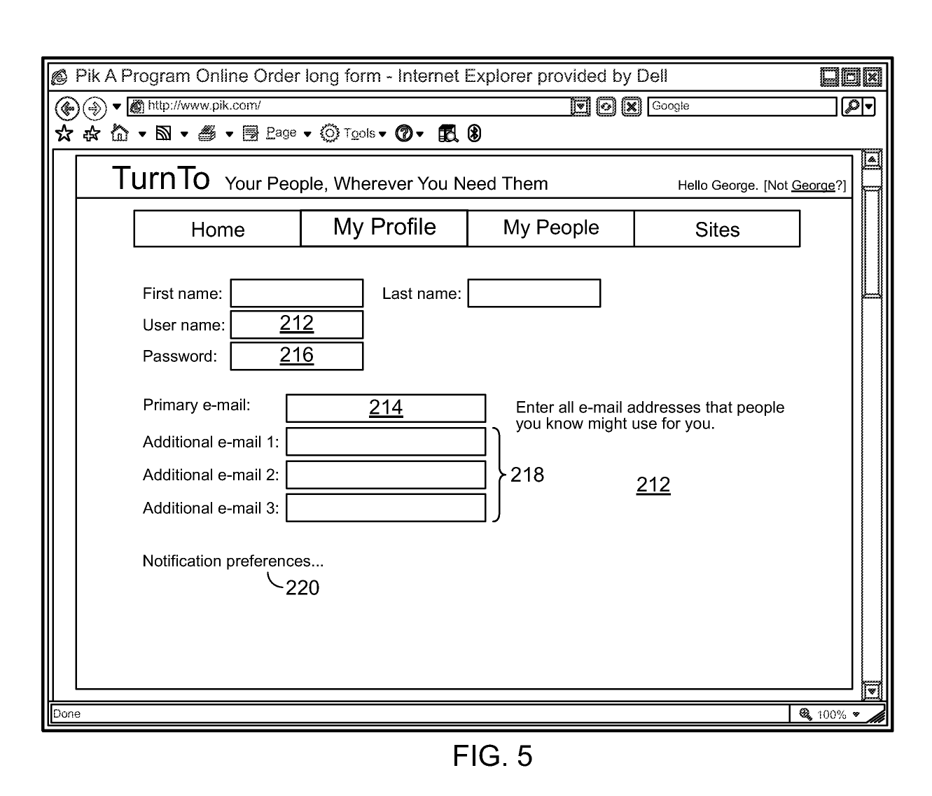

Clicking the My Profile button 208 of the navigation bar 202 invokes the page shown in FIG. 5. On this page, a new user can enter his profile for the first time or an existing user can alter his profile. Each member of the shared SN system can be identified within the system by a unique identifier, which may be a username 212, the user's email address 214, or another suitable ID mechanism. Access to all or part of a user's profile can be controlled by a password 216.

In addition, system users can provide all of the e-mail addresses 218 that might be used by their connections or by the affiliate sites to reach them. The user's email address can be used as a unique identifier that enables the system to cross reference user information stored on the shared SN repository with user information stored in the user records of affiliate sites. User e-mail addresses can also be used to import user connections from other sources. The system may require an e-mail confirmation step to validate that each e-mail address provided is legitimate. Other information about users may also be included in the profile, especially other types of contact information. In some implementations, the number and kinds of information that the user would be required to enter in his profile is kept small to enable a quicker sign-up and registration process, which may produce a higher volume of users. The user profile may also include information about the user's notification preferences, for example, whether the user wants to receive each notification in a separate e-mail or prefers the notifications to be bundled and delivered periodically.

### Two-Way Connections

A user can invite people he knows to be connections of his within the shared system. Each of the invitees may accept, decline, or ignore the invitation. If an invitee accepts, then a two-way connection is established between the users. In establishing this two-way connection, the user who extends the invitation and the user who accepts the invitation by doing so automatically are each deemed to have authorized (given permission to) affiliate sites that exist as of the time of the establishment of the connection and those affiliate sites that join later to share information that they may have or acquire about them, which might otherwise be considered private, with the other user in the connection. A system user agreement and privacy policies (and general explanatory text on the shared SN system site) can contain statements to this effect and other statements regarding the sharing of information. This permission model implemented by the system automatically enables an affiliate site to access and share the user's SN information from the system repository without requiring any further permission from the user SN.

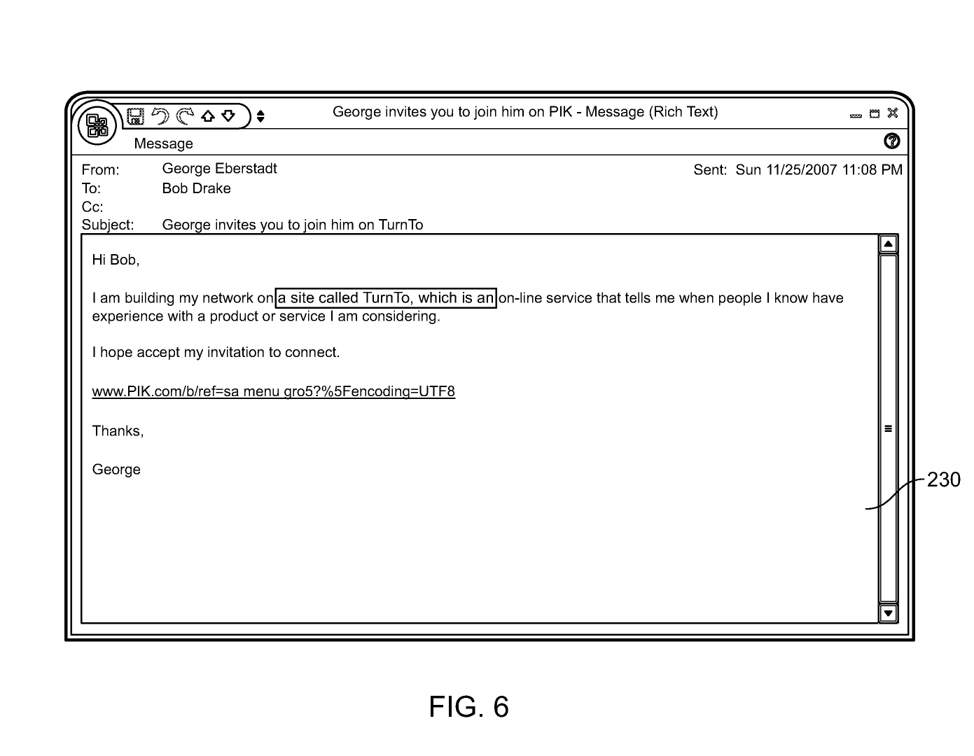

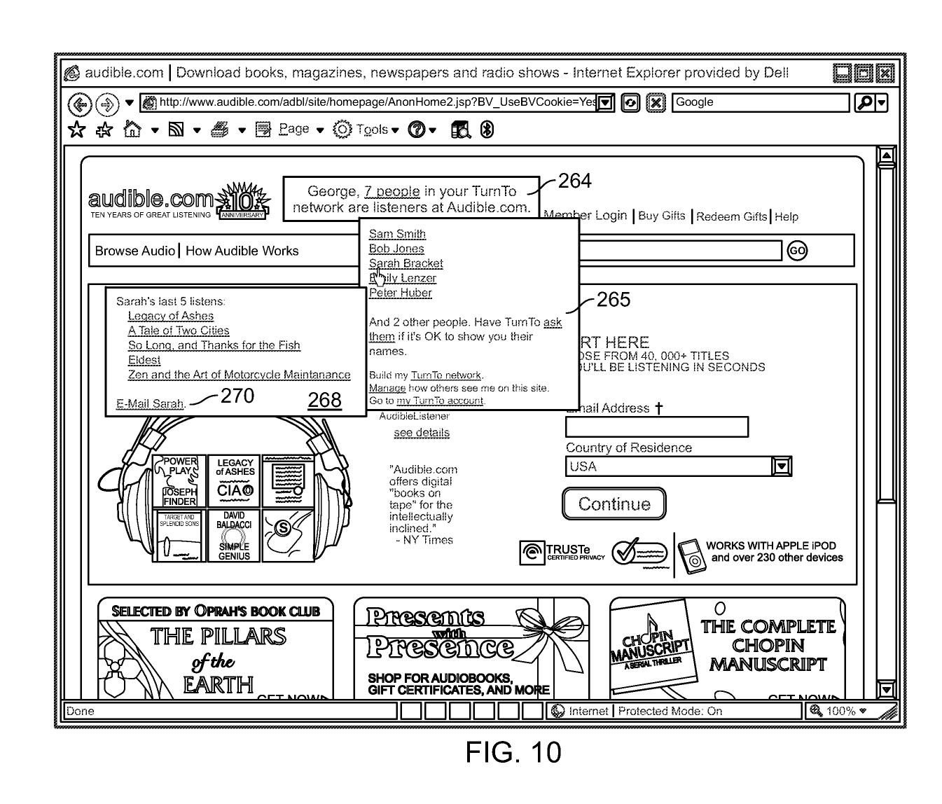

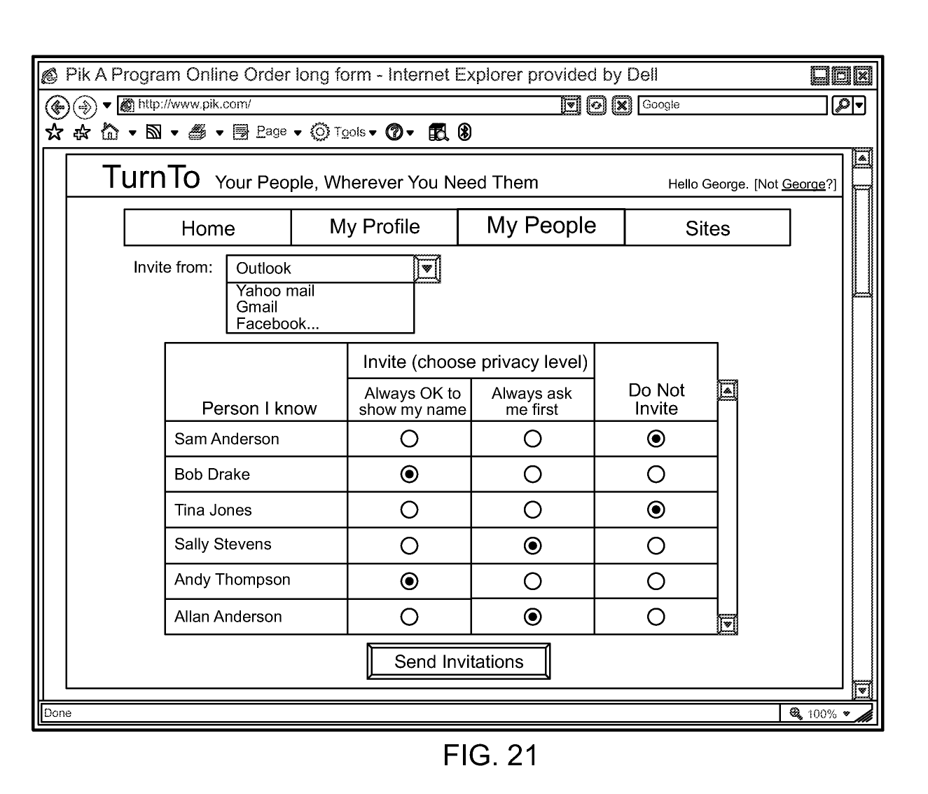

To specify a SN connection or create a connection within the system repository, a user can indicate (see FIG. 21) other people to whom invitations should be sent; the shared system then sends an invitation to the intended connection, generally as an e-mail, such as the e-mail 230 shown in FIG. 6 (in FIG. 10 and elsewhere, we sometimes refer to the shared SN system as the TurnTo™ system although a wide variety of other names could be used for trade purposes). (The user's knowledge of the invitee's e-mail address may be used as a mechanism to protect against invitation spam.) The e-mail of FIG. 6 may be generated automatically by the shared SN system based on information entered into a page to identify people the user wishes to invite.

In connection with the invitation process, the user can also set desired privacy preferences (e.g., permissions) for each invitee and add attributes or characteristics that describe the connection he intends to establish. If the invited connection is already also a system member, the connection need only accept the invitation and add his privacy preferences for the inviter and any connection attributes. On the other hand, if the connection is not yet a member of the system, the connection must both join the system and accept the invitation and add his privacy preferences for the inviter and any connection attributes. (The invitation e-mail can include information on becoming a system member.) The server of the shared SN system provides a user interface for extending (and accepting) these invitations and setting the privacy preferences and connection attributes.

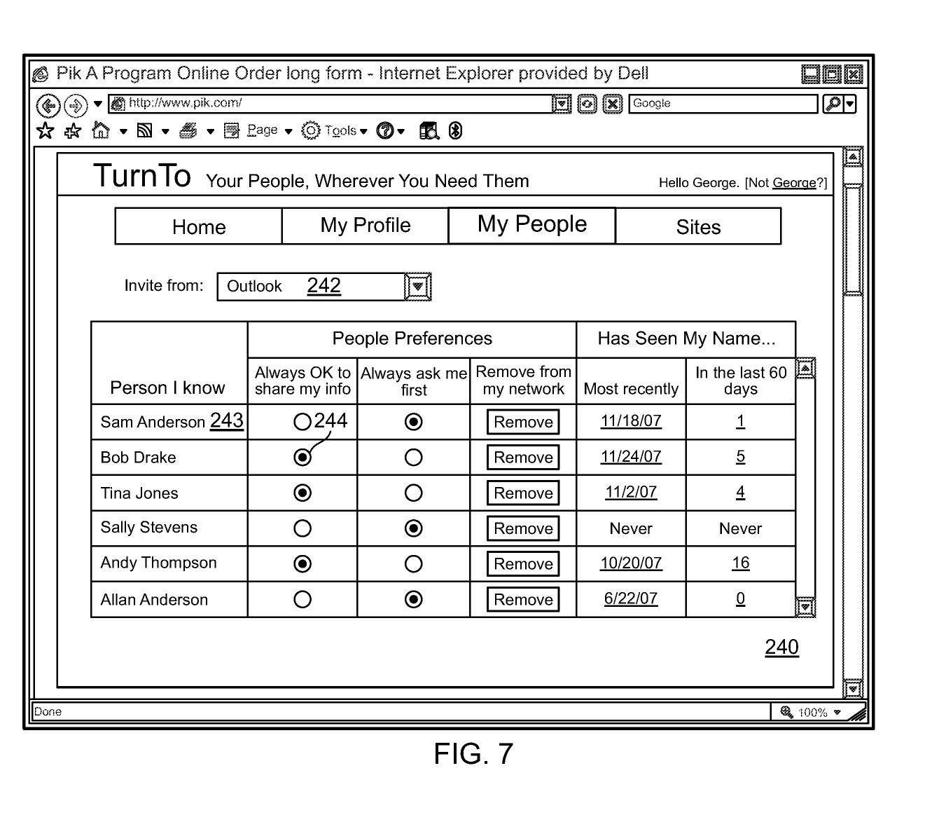

In one example of a tool to simplify the process of building a SN profile and connections within the system, as shown in FIG. 7, an example contact import screen 240 permits the user to select a contact management application such as Outlook in a box 242 and in that way to automatically send e-mail invitations to all of his Outlook contacts. Other techniques for easing the task of building a SN may include utilities for automatically exporting a user's contact list from web-based e-mail systems such as Yahoo, gmail, AOL, and others, and from a user's contact list and connection list from SN sites such as Facebook, MySpace, and LinkedIn.

Tools for performing these tasks can be arranged to enable the user to send multiple invitations and set multiple privacy preferences and connection attributes at the same time. In some implementations, a tool may present the list of all the contacts to be exported in a user interface (UI) that enables the user to easily designate, one by one, which contacts are to be invited, which are not, and which are to be deferred for later consideration. The user can set privacy preferences and connection attributes for each connection at the same time. The tool could enable the process to be rerun periodically to identify as new candidates any contacts that have been added to any of the source systems since the last export. Users could also designate contacts as persons of interest (POIs) with or without sending each of them an invitation to become a connection.

An invitation manager utility 132 in the shared SN system can be used to manage pending invitations. The invitation manager enables users to track invitations which have been extended but not yet accepted or declined and invitations they have received but not yet replied to. Invitations extended to people who are not yet system members can be held by the invitation manager until the person becomes a system member. In practice, it is possible for a person to accumulate many system connection invitations all of which will be presented upon the person becoming a system member. The invitation manager can match the e-mail address provided in the invitation to the e-mail address (or addresses) provided in the profile of the new system member.

### Ask-Me-First Preferences

A user of the shared system can control the manner, timing, and extent of his information that can be shared with any of his connections. In some implementations, a user can designate one of, for example, two or more levels of trust for each of his connections: a higher level of trust called, for example, “Trusted” or “Always Share,” and a lower level of trust called, for example, “Ask Me First”. An application or feature that uses the shared SN repository information may show a trusted connection a user's name, system profile information, and other information about the user held by a site, without consulting the user.

For example, in some implementations, an affiliate site for a resort can tell a user of the affiliate site (e.g., a prospective guest) if connections of his have stayed at the resort. The resort could provide the names (and perhaps the dates of the visit or other such information) of system members who have previously stayed at the resort and who have designated the prospective guest as trusted to that guest, without having to consult those system members.

In some implementations, an application or feature using the shared SN repository information may be prevented from showing a user's name, system profile information, and other information about the user held by the site to a connection designated as ask-me-first without first asking and obtaining permission from the user. In this case, the system provides a mechanism for requesting and logging that permission by e-mail or another method. In the case of the resort site, if some of the connections of the prospective guest have designated that person as ask-me-first, the application on the resort site must ask the connection for permission before sharing the connection's name or other information with the prospective guest. The request for permission could be done directly by the affiliate site or the affiliate site could request the system to make the request and confirm back to the affiliate site if the consent is obtained.

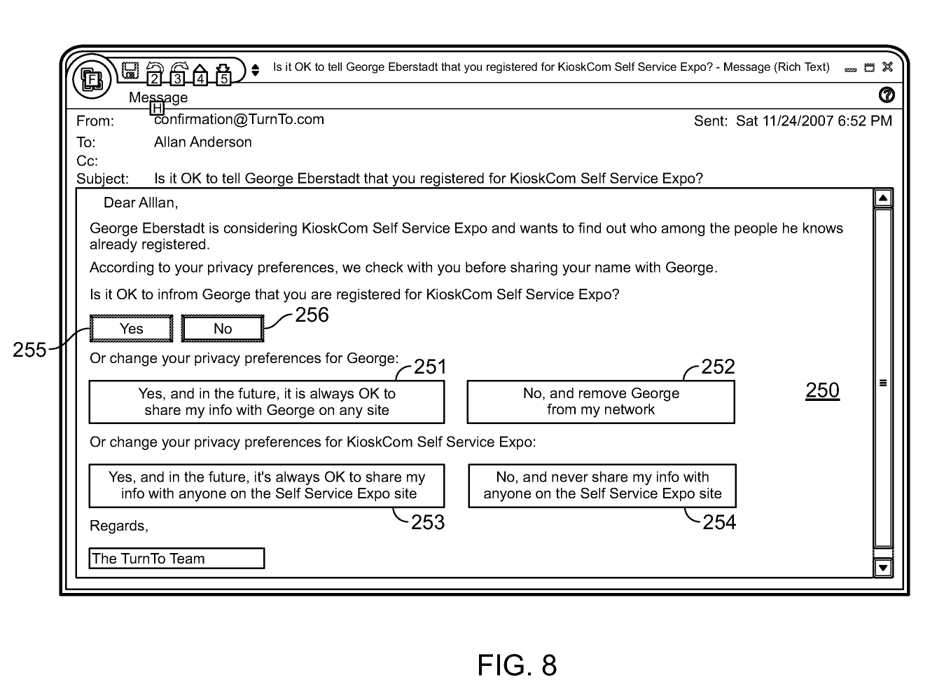

As illustrated in FIG. 8, if an e-mail 250 is used to ask a connection to accept or decline 255 or 256 a sharing of his information, an ask-me-first request could also provide opportunities for the connection to manage his general preferences with respect the user requesting the sharing or with respect to the site to which the request applies. For example, as shown in FIG. 8, the connection could be permitted, from within the e-mail 250, to switch his preferences for the user to trusted 251 or he could remove the user entirely from his connections 252. The connection could also, with the same e-mail, switch his preferences with respect to the site from, for example, requiring compliance with his connection-preferences to permitting site-wide trusting of everyone 253, or make-everyone-ask-me-first, or to opting out of the site entirely 254.

In the example of FIG. 7, a user of the shared system can indicate his privacy preferences (we sometimes use the term permissions to refer to preferences which include permissions, authorizations, consents, and other confirmatory actions) with respect to each of his connections 242. Radio buttons 244 can be used to switch between “always ok” to “ask me first” for each connection independently. A third column enables the user to remove the connection from his network entirely. The final two columns provide for reporting when the connection most recently viewed the user's name on an affiliate site and how many times he viewed the name in the past 60 days. A wide variety of other preferences and reports could be provided for each connection or groups of connections.

### Site Level Preferences

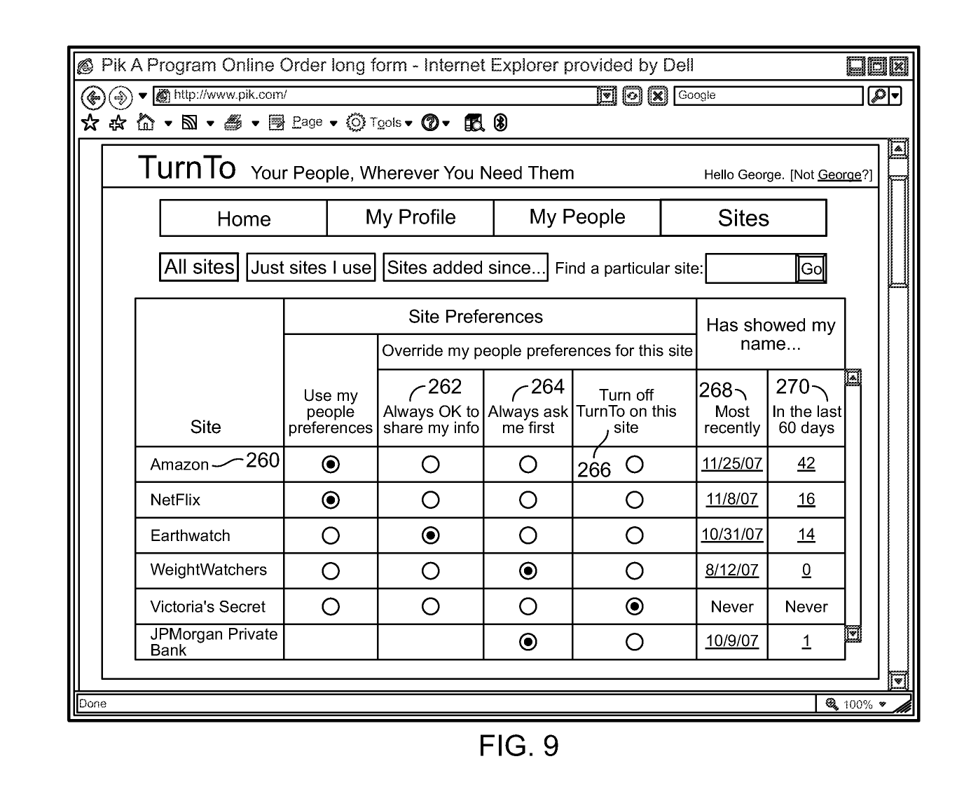

A user can over-ride a trust-level specified for individual connections (or more generally control the permissions to show his name and other information) on a site-by-site basis. For example, as shown in FIG. 9, on a page 258, a user may specify that at a given affiliate site 260, all connections are to be treated as trusted 262 or as ask-me-first 264, regardless of the trust-level otherwise specified by the user for each individual connection. A user can also opt out 266 of permitting his information to be shared with his connections, on a site-by-site basis.

At affiliate sites for which a user has opted-out, the user's name and other information will never be shared with the user's connections. In some implementations, in return for this privacy, the user will be denied the opportunity to see the names and information of his connections at that site (i.e., a user must be willing to share in order to have the information of others shared with him). The opt-out mechanism may be implemented with or without that behavior. Site-level preferences are recorded within the shared SN repository and govern the connection information that is provided to the affiliate site. For example, if a user has opted out at site X, the SN information provided to that site will exclude information about that user. The system user interface will enable users to browse a list of all the system affiliate sites or search for particular ones to simplify the process of expressing such site-wide preferences. The interface can provide a search for affiliate sites based on the date on which a site became an affiliate to enable users to more easily express site-wide preferences on sites which became affiliates after the user last reviewed the list.

### Other Attributes of a Connection

When a shared system user makes a connection, the system may provide the user with the ability to characterize the connection by certain attributes. For example, the user may specify that his relationship to the connection is a personal one, a professional one, or both. The user could also specify the context in which the connection was made in the real world, for example, at companies at which the users were colleagues or schools they attended together. This context information may be one-sided or require two-sided verification. For example, a user can specify that he knows a connection from having worked together at company X with no confirmation as to the truth of the statement required from the connection (i.e., one-sided), or that information may be held in an awaiting-validation state until the connection has confirmed it (i.e., two-sided). This relationship characterization information may be provided to affiliate sites to enable them to tailor their use of shared repository information. For example, a resort site could use only connections characterized as personal in showing a user which of his connections have stayed there, in order to remove the possibility of sharing such information with a business connection of the user.

### Multiple Networks

An alternative mechanism for enabling affiliate sites to tailor their use of repository information is for the shared repository connection information to be organized in multiple networks. Rather than tagging connections with attributes to differentiate them, the connections could be held in logically separate networks. For example, the system could manage one network for professional relationships and another for personal relationships. A connection between two users could exist within either or both. When a user invites another user to be his connection, the user could specify which networks the connection is being invited to join. Affiliate sites could subscribe only to networks that are relevant for their needs. As in the example above, a resort could subscribe to the personal system network, thereby limiting information sharing to personal connections of each user and excluding professional connections.

### One-Way Connections

Users may be permitted to designate connections that are one-way within the system, and are called “contacts” or “people of interest” (POI). (In this document, we use the word connection in a very broad sense to include, but not be limited to, one-way, or two-way or other particular types of connections.) No reciprocal confirmation of a relationship is required for the designation of a POI. A user need only have a way to identify the person within the shared repository. (A member-search function may be provided for that purpose.) The designation of a POI does not entitle the user to access any private information about the POI within the system or at affiliate sites, but it would enable affiliate sites to bring public information about the POI to the attention of the user. For example, at a photo sharing site, photos posted by a POI for public viewing may be highlighted for the attention of a user (useful in a sea of public photos). Private photos would only be shared in accordance with a two-way connection between the users.

### Groups

Users can establish groups within the shared system repository. A group could establish the same permissions that two-way connections provide (and others as well) but the permissions would apply to all connections among members in the group. The creation of a group would save members from having to establish separate two-way connections between each pair of members of the group and to maintain those connections as members enter and leave the group. (In effect, a connection is a special case of a group having two members.) Privileges would be designated for certain members of the group to manage membership in the group and the ways in which affiliate sites could employ the group connections. A group would be useful in a case, for example, where there is a large but often-changing network of connections that would be desired for use on multiple affiliate sites. For example, a club of book-lovers might establish a group of all its members (a list that changes frequently) that would be used by multiple book-selling and book enthusiast affiliate sites to facilitate interactions among the club's members at each site. We use the term group in a broad sense to include, but not be limited to, the example explained above, contact lists in contact managers, and other ways to identify sets of people.

Use of Existing Connection Information from SN Sites

For a SN site that enables third-party applications to access the site's SN information, for example Facebook and LinkedIn, it may be possible to build an application that would continuously import complete connections to the shared SN system as they are formed within the SN site. The connections could be imported directly from facilities that deliberately expose them to third parties, or could be scraped from the Internet by other techniques, or could be acquired in other ways.

For example, in some implementations, Facebook user A could install a Facebook application for the shared SN system and automatically become a member of shared SN system. Facebook user B, who is a connection of user A within Facebook, could install the Facebook application and also automatically become a member of the shared SN system. Facebook user B would also have a connection with A within the shared SN system because of the connection within Facebook. Facebook user C, who is a connection of both A and B within Facebook, could install the Facebook application and automatically become a member of the shared SN system and a connection of both A and B within that system.

In some implementations, the shared SN system can be structured to adopt future technology and standards supporting SN portability. For example, Google™ recently announced a set of standards defining how applications can access SN information, called OpenSocial. The shared SN system could adopt OpenSocial as the means for shared SN system-enabled applications to access shared SN repository information.

### Use of the System by Affiliate Sites

To promote adoption of the system by third party affiliate sites, the system provides general purpose applications that make use of the system repository and can easily be incorporated by many potential affiliates in their own sites. One such application, which would be significant in the realm of online commerce, for example, is the “Trusted Reference” application.

### The “Trusted Reference” Application

As illustrated by example in FIG. 10 with respect to Audible.com®, in the Trusted Reference application, a prospective user of an affiliate site who is also a member of the shared system, upon coming to the affiliate site, is greeted with a message 264 of the form “Hi <username>. <number> people in your system network <have done whatever the user is contemplating doing>.” In another example, at an electronics shopping site where the user is considering purchase of a camera, the message might say, “Hi Bob, 4 people in your network have bought cameras at <this site> in the last 6 months.”

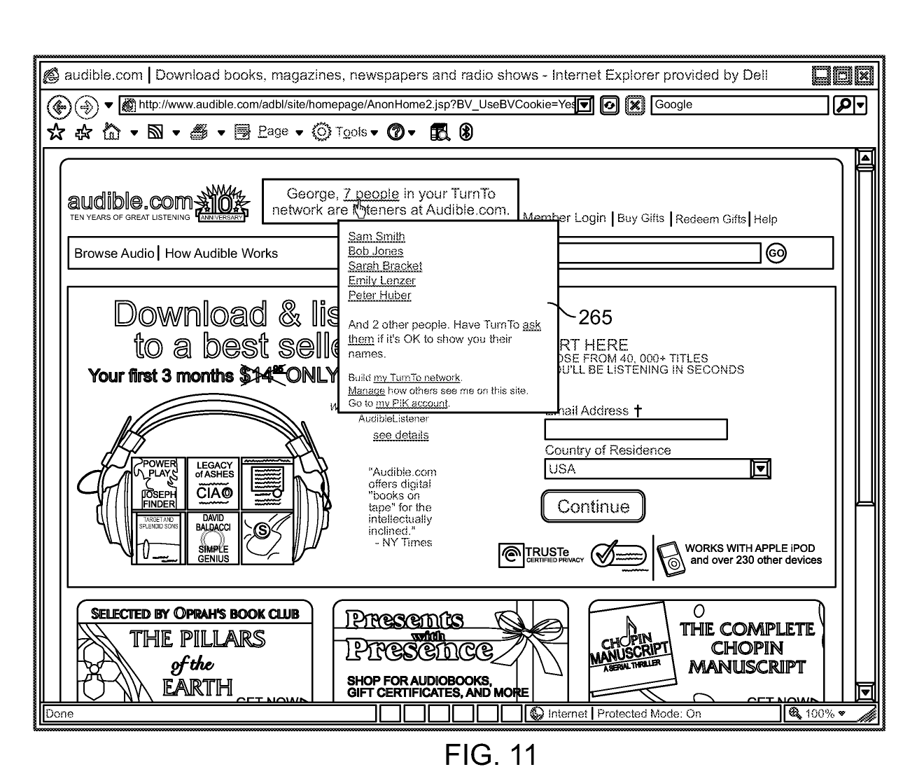

By clicking on the link in this message, the user is shown the names 265 (FIG. 11), of all (or some subset of) connections who have designated him as trusted and is given the chance to request the system to ask any users who have designated him as ask-me-first whether they will permit their name and information to be shown to the user in this context. If ask-me-first connections give permission, the user is alerted (according to the user's notification preferences) and that connection's name then appears along with those who have designated the user as trusted.

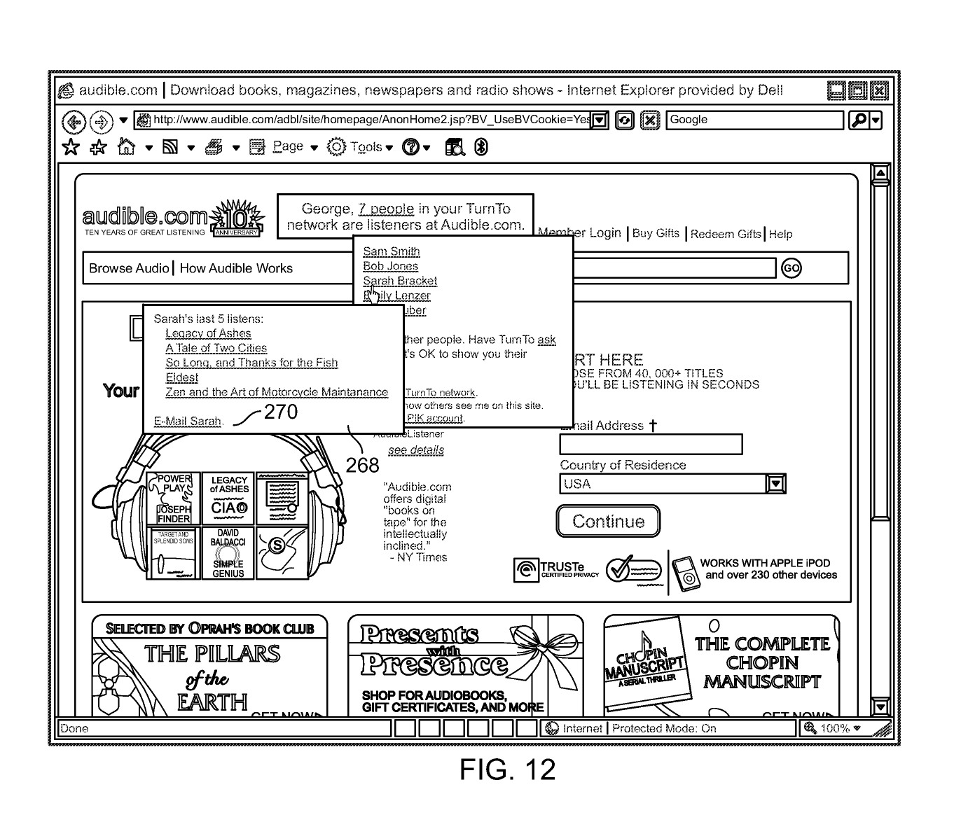

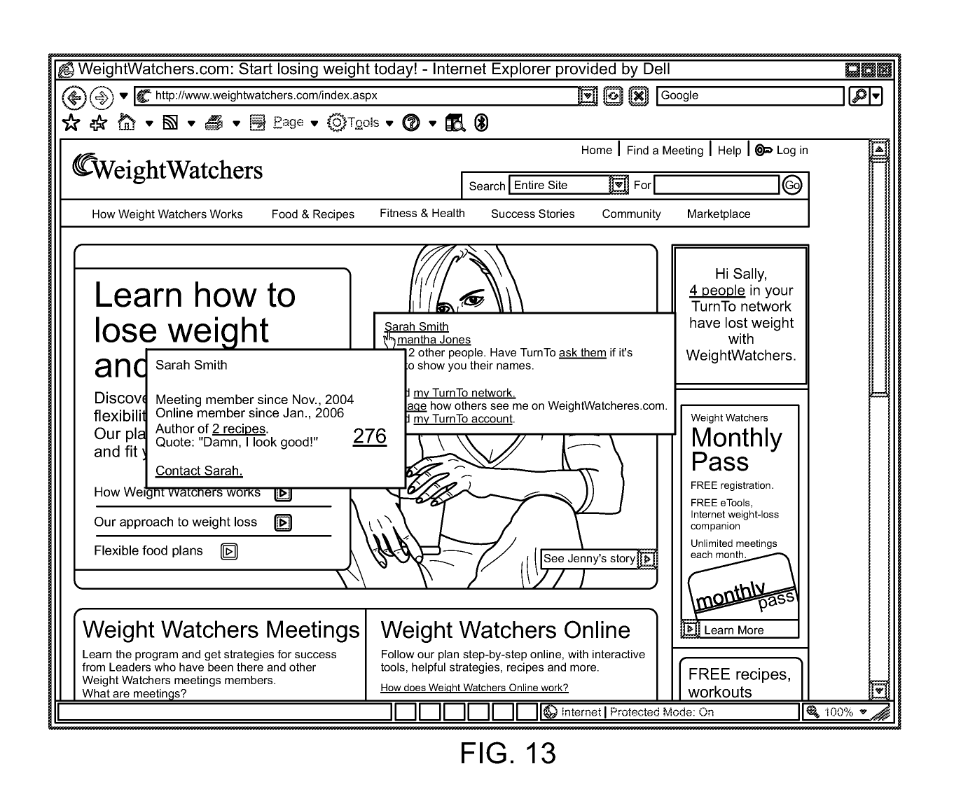

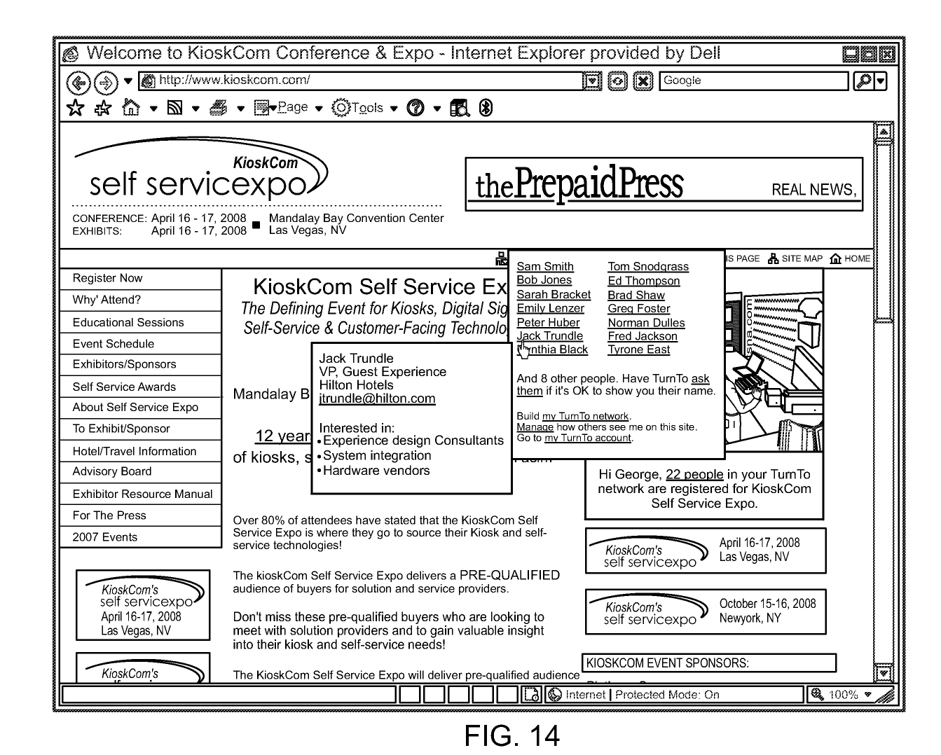

The affiliate site's application may be configured to enable additional information about each connection to be shown. In the example above, in response to the user clicking on a connection's name, the application could show which camera that connection bought at that site. Another example of additional information that can be displayed is information 274 in FIG. 13, with respect to an illustration using the WeightWatchers® site as the affiliate. In the example shown in FIG. 12, the last five listens 268 on the Audible.com affiliate site are shown to the shared system member. A link 270 enables the user to immediately send an e-mail to the connection. Alternatively, the affiliate site might show all products that the connection has bought at that site within some period. Or it could show any product reviews that have been written by that connection at that site. Yet other examples of information that can be displayed are shown in FIGS. 14, 22, and 23.

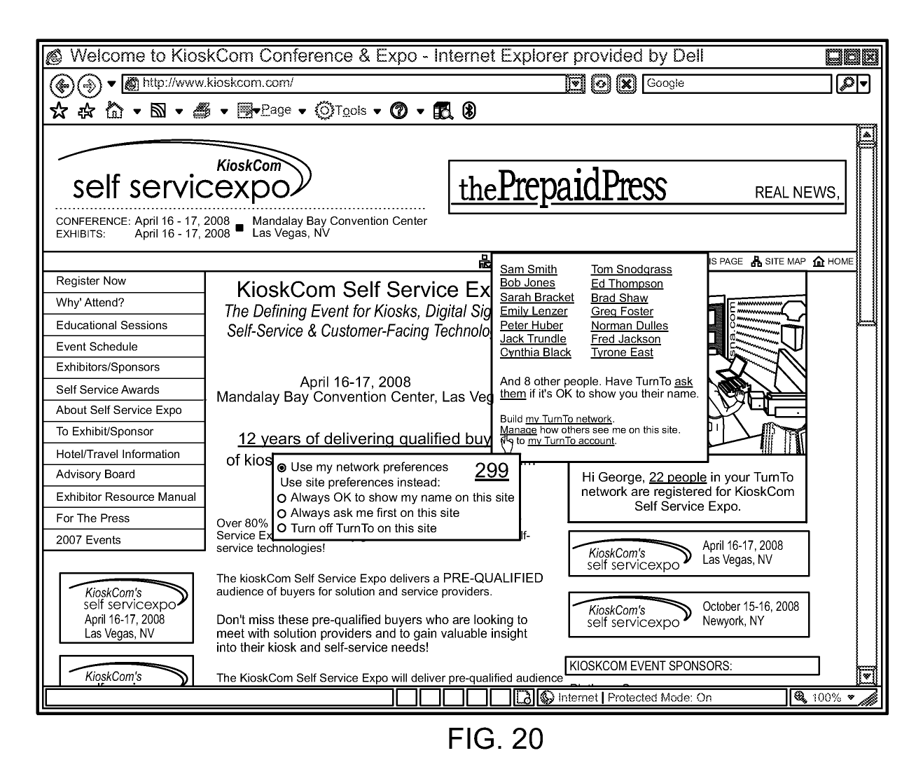

In some applications, for example, as shown in FIG. 20, when a user clicks on a link indicating a desire to manage his permissions, a box 299 opens to enable him to adjust his preferences.

In some possible implementations, when a user is considering an action or engaging in an activity (e.g., buying a camera, joining an association, going to a resort, attending a conference, or hiring a vendor), the application could share trusted references with the user at just the moment (or at a time related to) when the user is considering the action. While users will sometimes know some of their connections to whom they can turn for advice on particular topics, they will often not be aware of everyone in their network who has relevant experience, and so may miss the chance to consult. The trusted reference application makes it more likely that the people with relevant experience can be located.

The Trusted Reference application works by finding names that appear in common in a list of the user's connections, provided from the shared SN repository, and a list of users provided from the affiliate site's repository. In building and using its applications, the affiliate site has the flexibility to filter the list of names from the shared SN repository for the comparison in any way it chooses. By way of a few examples, connections could be filtered based on all shoppers at the affiliate site, only those who have purchased cameras and only in the last six months, only those who have agreed to be references or who have high customer satisfaction scores, or only users who have been members longer than 3 years, and in a wide variety of other ways. In addition, the affiliate site's application could combine several of the filtering criteria. Once the list of trusted connections has been generated, the application can, if it is configured to do so, obtain additional information about those connections from the affiliate site repository to share with the user. The Trusted Reference application identifies the user by cross-referencing his unique ID used to access the affiliate site. The Trusted Reference application can query a browser cookie set by the affiliate site to identify the user. When user information is not stored in a browser cookie, the shared SN system can set its own cookie to identify the user. This enables the application to show a user his trusted reference list even if the user does not yet have an ID with the site.

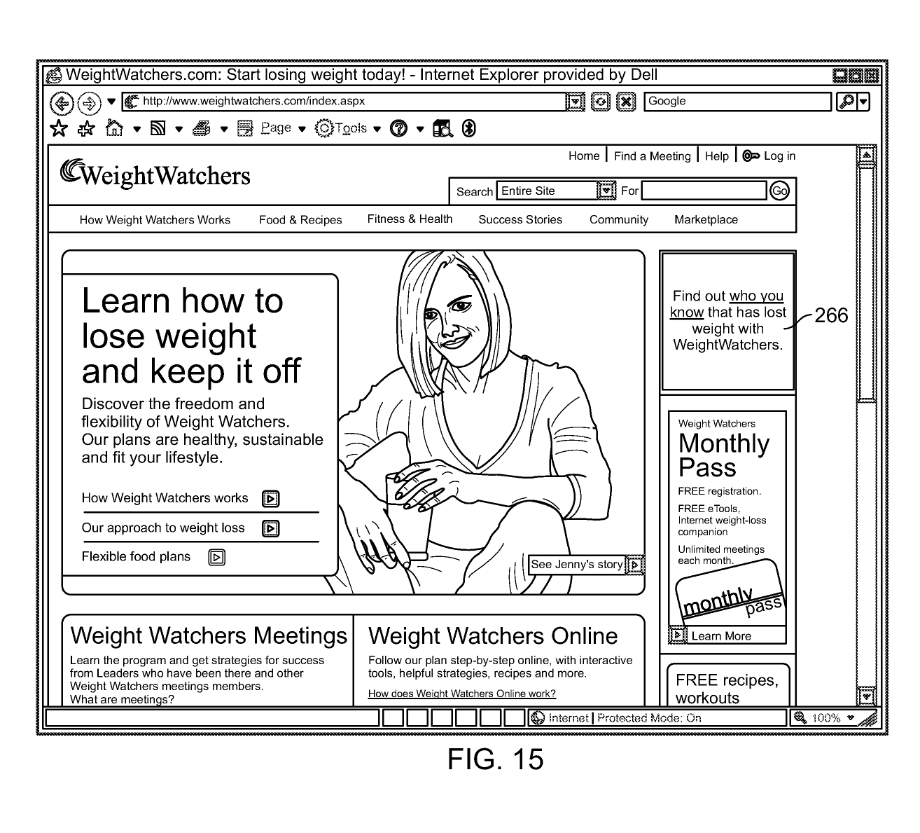

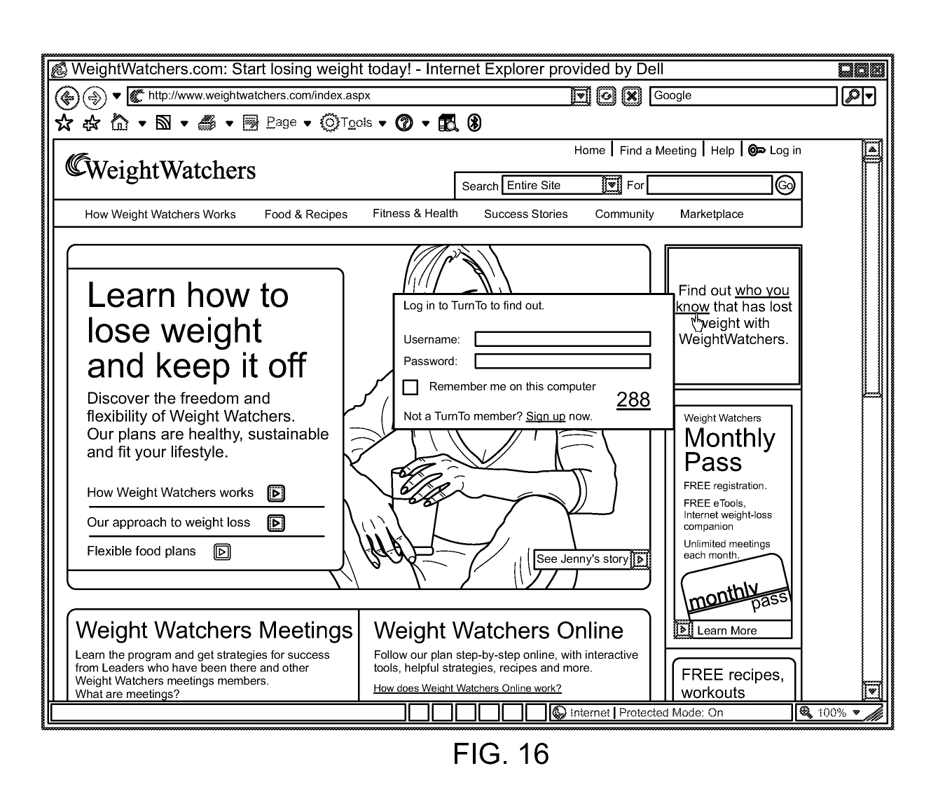

If a user who is not yet a shared system member enters an affiliate site employing the Trusted Reference application, the user will see a message such as, “Find out who you know that <has done whatever the user is contemplating>.” (This is illustrated for WeightWatchers® as message 266 on FIG. 15.) Clicking on the link in this message will open a dialog box 288, FIG. 16, that asks the user to log in if already a shared system member (in case the system lost the cookie identifying the user), or inviting the user to become a system member if not already one. If the user clicks on the invitation message, he is led through the enrollment process. This feature allows each affiliate site to be used as a recruiting point for members for the shared system.

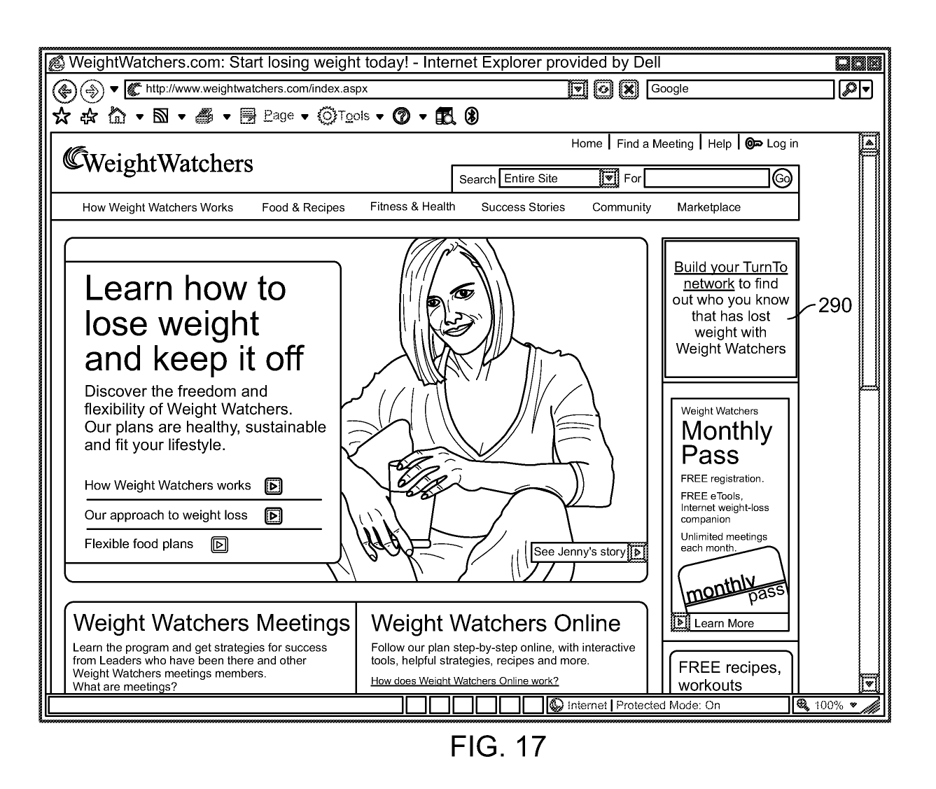

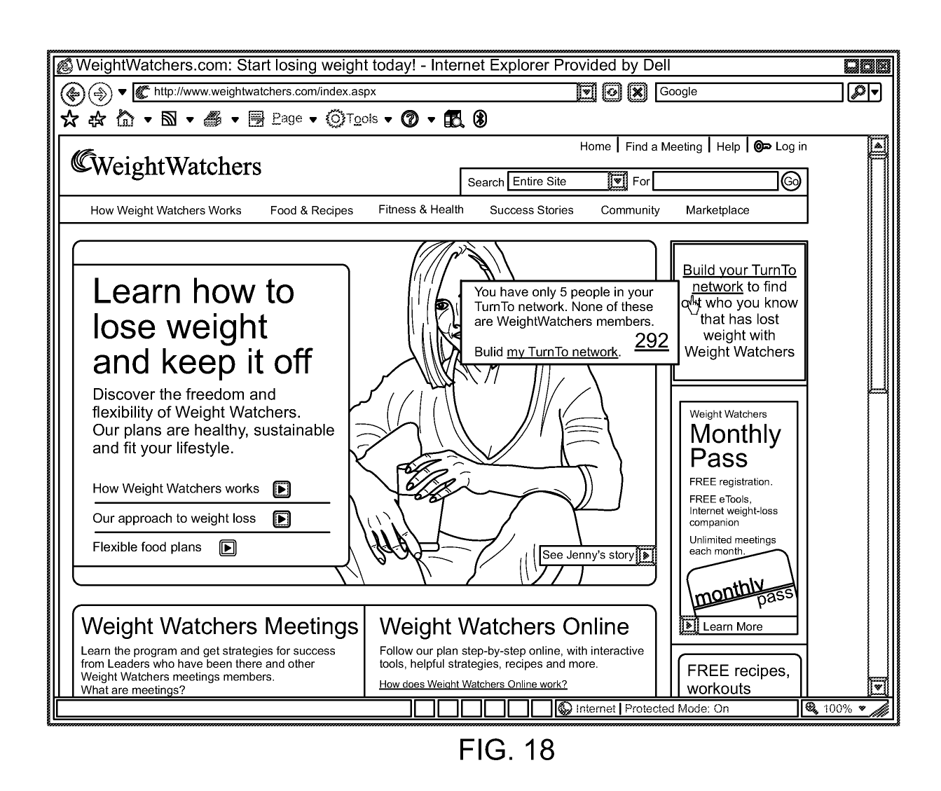

If the application recognizes the user as a shared system member but identifies no trusted references of the user, the application can determine whether the user has a number of connections in the shared system repository that is larger or smaller than a threshold amount (which can be set by the affiliate site). If the user's network is smaller than the threshold, a message can be displayed to the user, for example, “Build your system network to find out who you know that <has experience with whatever the user is considering doing>” as illustrated in FIG. 17, message 290. Clicking on the link could call up a dialog include a message such as, “You have only <number> people in your system network. None of these <has experience with whatever the user is considering doing>. Click here to build your system network” (for example, message 292, FIG. 18). If the size of the user's network is larger than the threshold, then the application could be set to display no additional message. An affiliate site can set the threshold level based on whether it is eager to encourage users to grow their shared system connections or concerned about troubling users with too many reminders.

### Other Applications

As affiliate sites gain experience with the use of the shared SN system and repository, the range of applications employing repository information may grow. The shared system can provide tools to simplify the creation of these applications and provide services to support affiliates in creating system-enabled applications. A very broad range of applications and features can be developed. A few illustrative examples include the following. The display of content created by a user's connections or POIs can be prioritized (e.g. reviews, blog entries, and photo postings). Alerts can be triggered when connections are physically near each other. Quizzes, games, and contests can be established between connections. Trusted references can be provided on prospective employees and trusted references can be provided for applicants on the companies they are considering joining. User profiles can be compared to identify things that connections have in common and areas of differences. Connections can be automatically alerted when users achieve certain milestones or when a trigger event occurs.

### Contextual Preference, Network and Account Management

Dialog boxes may contain other links, including an invitation to the user to add to his shared system connections, a link to his system account on the shared system site, a link to a page describing the affiliate site's policies for use of shared repository information, and a link to a dialog that enables the user to manage his site privacy preferences (some of these features are illustrated in message 265 of FIG. 21). This last dialog could provide options for the user to over-ride the trusted/ask-me-first preferences for individual connections with site-wide preferences such as trust-all-my-connections-on-this-site, treat-all-my-connections-as-ask-me-first-on-this-site, and opt-me-out-of-this-site.

### Policies

The interests of an affiliate site and its users are generally aligned in that the site wants to provide value to its users and does not want to embarrass or alienate them by sharing private information in ways those users would not want. Because the means for achieving these ends may differ from site to site, the shared SN system is designed to allow affiliate sites flexibility in how they use the repository information. A first recourse for a user who is unhappy with an affiliate site's use of information about the user that it has acquired from the shared repository could be to set his site-wide preferences for that site to “ask-me-first” or to opt out of system functions on that site entirely. The shared system can establish guidelines of acceptable use that affiliate sites will be required to follow. The shared system may refuse to allow sites that won't comply to become affiliates or to shut off affiliate sites that violate the policies. To further aid dispute resolution, the shared system can enable users to report abuse or misuse by affiliate sites.

For affiliate sites to provide privacy behaviors for shared system-enabled applications that are appropriate to their businesses, affiliate sites will be able to use the shared repository information in a more restrictive way than that required by the terms of use and privacy agreement that the shared system has with its members or that the shared system members themselves have specified. For example, a site may itself choose to use only a shared system personal network and not a shared system professional network (if the system employs a multiple-network model), or it may choose to use only connections flagged as personal and not those flagged as professional (if the system employs the connection attribute model). Also, a site could specify that all connections are treated as ask-me-first regardless of the users' connection settings to provide all users with the opportunity to decline every instance of information sharing.

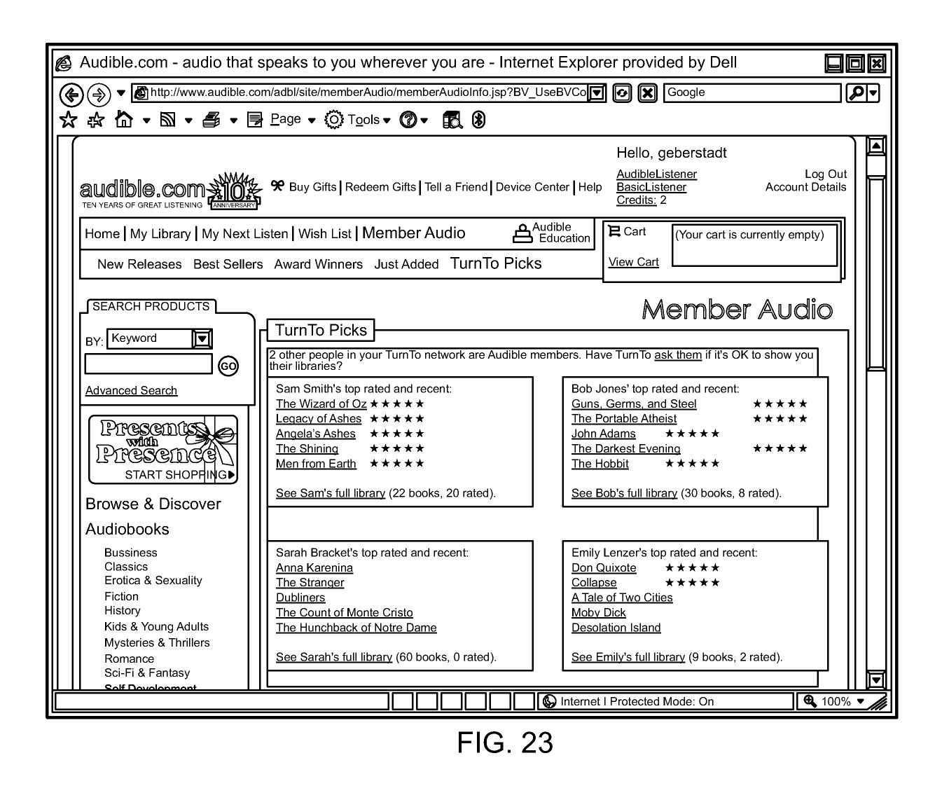

The message 280 on FIG. 23 is an illustrative example of an affiliate site for a private banking service that would not share connection information without first asking the connection.

Integration with Affiliate Site Information

To aid an affiliate site to build a shared system-enabled application, the shared system may provide tools to simplify the integration of the system-enabled application with existing user and customer records. For example in one implementation, an App Exchange application program is provided for the Salesforce.com site. This application enables sites and businesses that have user and customer information in the Salesforce.com system to easily specify which records and which information elements are to be provided to the shared system application. Other similar connectors can be built for other common repositories of user and transaction information.

### Registration of Affiliate Sites

In some implementations, each affiliate site is registered with the shared system and can be listed with corresponding applications within the shared system. The shared system user interface would enable users to express site-wide preferences for all affiliate sites from a single location. (If a single site uses of information from the shared repository for more than one application, the individual applications may be registered separately.) The affiliate sites will provide descriptions of the functionality of the applications as part of the process of registering a shared system application and this description will be available at the shared system site.

Passing of Information from Affiliate Sites to the Shared System

The shared system enables applications to function without requiring affiliate sites to share any information they maintain on their users and their users' activities with the shared system. In some cases, the freedom to use the shared repository information without sharing site specific user information with the shared system may be an advantage to affiliate sites. However, in some implementations, the shared system may also acquire information from the affiliate sites.

The applications may send to the shared repository logs of when, in what context, and by whom information on each shared system user was viewed. This information can be used to provide reports to users regarding the visibility of their names. It can also be used to provide reports to affiliate sites on the use of their applications. And it can be used by the shared system itself to evaluate use of the system.

In some implementations, applications may also send back to the shared system profile or activity information from the affiliate sites on system members. This information may be aggregated to enable analyses, reports, and applications that span affiliate sites. For example, a shared system user may buy books from multiple affiliate sites. By aggregating such purchase information for the shared system member across all affiliate sites, connections of that user could more easily discover whether that user had bought a particular book on any of those sites. Such analyses could be made available to users at the shared system site, or the aggregated information could be provided back to the affiliate sites to power multi-affiliate applications that run within the affiliate sites.

Other implementations are within the scope of the following claims.

Among other applications, the shared system could be used in connection with recruiting (to find people who know the candidate), job searching (to find current employees who have information), attendance at conferences (to find people who are planning to attend), reading (to find people who have read an item, or to find items authored by people you know), podcast listening (to find other people who have listened), association membership (to find people who are already members), game competition (to find people who are already using the game), instant messaging or online emailing (to find people who are available to communicate), or location seeking (to find people who are physically near to you). Any application in which users wish to know about activities of people with whom they are connected, and also to be able to control the access of others to information about their own activities would be a potentially good application for the shared system. More generally, the shared system would support applications in which users can maintain connections with people they know, learn about the activities of those people in a wide range of contexts, and be able to constrain the release of their own information to individuals, groups, or users of a site or other facility.

For example, the affiliate may include a site, mobile application, client-server program, or any program that interacts with other users through, e.g., an online connection.

Possible applications include commerce recommendations, employment references, conference registration support, discussion of particular articles, other recommendations, associations, games, and location references.

In some examples, the shared system could build and offer members its own applications running within the system online service environment. The shared system could enable third-party applications, including those from affiliate sites, to run within the shared system environment.

In some implementations, connections between two people can be created and maintained in the shared SN system 100 in a mode that does not require bi-directional acceptance of the connection by both of the people associated with the connection.

In a bi-directional mode (for example, as described earlier), one of the people associated with the connection asks the other person to consent to the creation of a connection between them. Unless the other person consents, the connection is not created. Once the other person does consent, a connection is created in the SN database. The bi-directional model is useful when the information that will become the subject of sharing between people who have a connection is non-public information that each of the people does not want to share generally. Facebook and LinkedIn are examples of sites that use a bi-directional consent mode.

When the information to be shared by a party is not private, however, a more relaxed mode of control of the creation of entries in the SN database may be used. In this people-of-interest (also called contacts) mode, described earlier and also used by a site called Plaxo Pulse, no confirmation or consent is required from the person whose information is to be shared. Instead, only a one-way action by the person who is interested in being made aware of the non-private information of the sharing party is required. Once the receiving person identifies the other person as a person-of-interest or contact and that identification is stored in the database, the receiving person receives the non-private information. The non-private information could include, for example, pictures that the sharing party has posted publicly on Flickr (a public photo-sharing site) or comments that the sharing party has posted publicly on a blog. Because the information about the sharing party is already public, there is no need to ask for permission to obtain it and deliver it to the requesting party. The SN system can simply automatically track, aggregate, and deliver the information.

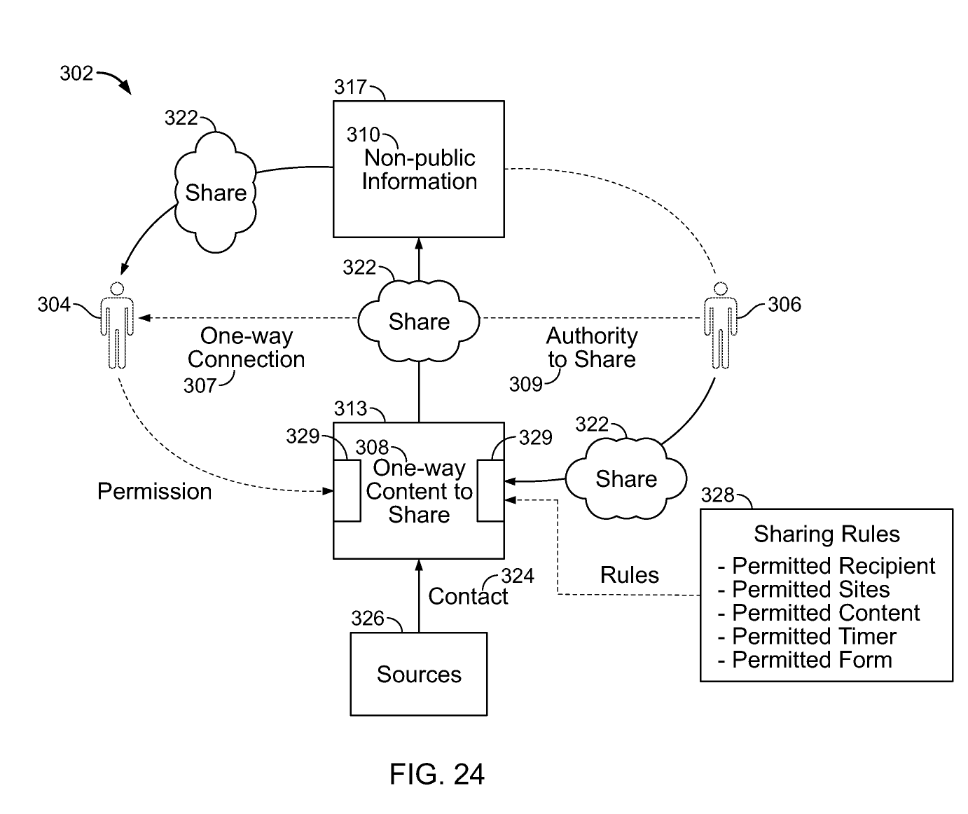

As shown in FIG. 24, some implementations of the system described here use a mode, called a one-way sharing mode 302, that does not require two-way agreement by two people 304, 306. Instead, a one-way consent 308 by a person 306 can be effective for, e.g., a third party 312 to be allowed (e.g., to have authority 309) to share information 310 (e.g., non-public information) of person 306 (sometimes called the sharer) with person 304 (sometimes called the recipient).

In this one-way sharing mode, the sharer 306 authorizes sharing (and controls how, when, in what context, to what extent, and to whom the sharing occurs) of the information 310 associated with the sharer. The non-public information can be information under the control of any third party 312 (sometimes called an information holder), for example any third party site, repository, database, or other facility or feature that is accessible through any kind of communication medium 322.

In the one-way sharing mode, only the sharer needs to consent to the sharing. No consent is required by the recipient, because the consent does not allow access by anyone to non-public information associated with the receiving party and so consent by the recipient is not needed.

In this sense, the one-way sharing mode establishes what can be thought of as a one-way connection 307, in which, e.g., private information can flow in one direction to (be shared with) recipients, but not in the other direction (without the consent of the recipient party). In another conceptual view of the one-way sharing mode, there is no conventional connection established between the sharer and the recipient. Only a one-way consent is provided to the SN system 313. The consent flows from the sharer to the system 313 and the information flows from the third party 312 (e.g., a site under independent control from the system 313) based on the authorization 309 from the system 313 to the site 312. The recipient need never provide consent back to the sharer, need never know that the sharer has provided the original consent, and need never be consulted about the consent. The access to the non-public information of the sharer occurs transparently without the recipient being aware of the arrangements that have been made for the sharing.

Through a user interface 329, the SN system can enable the sharer to specify detailed rules 328 that define from which sources information may be provided, which information may be provided, when, to whom, in what context, and in what form.

In some implementations, a user who wants to be a sharer can import his contacts 324 into the shared SN system from other sources 326 or can enter the contacts manually. For each contact or groups of them, he can specify the rules that will be used to control sharing with the contact or group of non-public information about the sharer held by each affiliate site 312 of the shared SN system.

A wide variety of rules can be specified for each identified receiver (individual or group). The rules can be specified receiver-by-receiver, can be based on attributes about the receiver, or can be based on groups to which the sharer belongs.

The rules can be specified site-by-site, based on site types, or drawn from default settings and later customized in a way similar to the ones described earlier. The contacts do not need to have links or connections to the user nor to have agreed to share with the user in order to be able to receive information that the user has agreed to share with them.

In some implementations, when a sharer sets rules for sharing that identify a recipient, the rules are stored in the shared SN database. The rules can be set even though the recipient is not yet a participant in the shared SN database. In that case, the sharing rules for a contact can be set and stored in the SN database. However, until the recipient joins the shared SN system, the system may not be able to authorize the sites that are the information holders to share the information. Once a targeted recipient has joined the shared SN system, the system can simply match the newly joined recipient with the previously stored sharing information, and the sites that are the information holders can immediately and automatically be provided with the authorization needed for them to share the non-public information.

Thus, in effect, in some implementations, the process of creating connections (e.g., one-way consents) that can be used for information sharing is disconnected from the process of sharing. Conceptually this can be viewed, for example, as sharing without creating a conventional SN connection, or can be viewed as establishing a new kind of one-way SN connection.

A sharer can unilaterally choose to share his non-public information with a recipient without needing to invite the recipient to share in return. Conversely a potential recipient can invite a sharer to share his private information without offering to share his own information in return, and a sharer can share and at the same time invite the recipient to share back.

Among possible applications of the one-way sharing mode are the following.

An affiliate site of the shared SN system could run a promotion to motivate its current members to register as participants in the shared SN system. The identified recipients who are using the affiliate site would then immediately and automatically become recipients of non-public information of these people, who are presumably their friends and therefore trusted sources.

For example, site X could offer one month free for any member whose name is viewed as a reference (or for whom non-public information is made available to the member in any other way) at least ten times through the shared SN system. This would encourage members to sign up as sharers for the shared system and to add large numbers of contacts to the shared system, with generous sharing rules. A person who visits the affiliate site and is not a participant in the shared system would see a box that says “Want to know if friends of yours are already members of site X? Click here to find out.” By clicking and signing up for the shared system, that user, without having to authorize any sharing of his own information, immediately can see many references on the affiliate site (e.g., people they know who have agreed to share information with them).

The one-way mode takes advantage of the fact that people may be more willing to share their information with friends than to request their friends to share with them. In a two-way consent mode used to set up a conventional connection, a user may be reluctant to bother his friends to engage in a consent transaction, but not reluctant to volunteer his own information to his friends. A user who might add only ten contacts to a two-way consent system (and those ten may result in ten consents in the return direction), may be willing to add 400 more contacts in a one-way sharing model.

One possible concern associated with a one-way sharing mode is the possibility of a user generating spam by listing thousands or millions of contacts and allowing generous sharing. This concern can be addressed in a variety of ways, including the following:

The number of contacts a sharer may identify may be limited and a CAPTCHA mechanism can be used to restrict automated registrations.

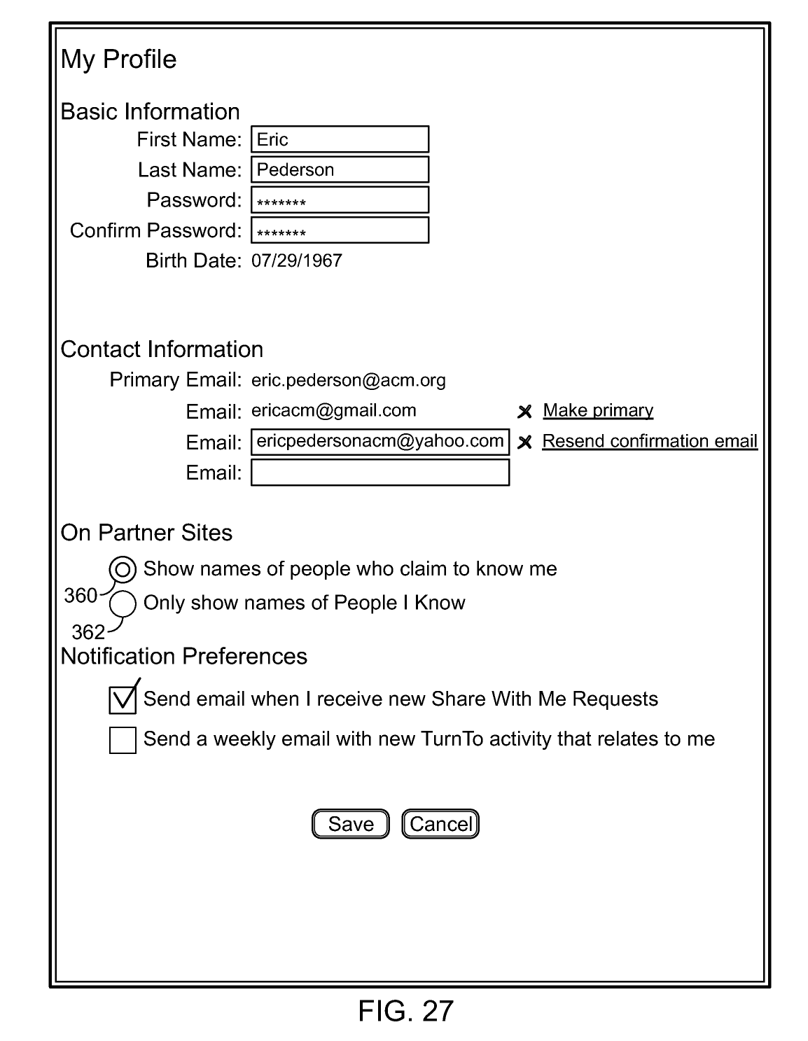

In some implementations, a potential recipient could be permitted to specify through the user interface 309 whether he is willing to receive information that is shared by anyone who claims to know him or only information from people who are in the contact lists of the potential recipient. As shown in FIG. 27, for example, the user interface can enable a recipient who registers as a participant in the shared SN system to use radio buttons whether, on affiliate (partner) sites, he is willing to see the names of anyone who purports to know him 360 or only of people whom he knows (his connections, for example, in the database) 362. In an early stage of implementation, users could be encouraged to allow sharing by anyone who claims to know them (as a way to generate more referrals for the benefit of the affiliate sites and the shared SN system), and to switch the setting to only-people-in-their-contact-list if they find they are getting too much sharing from people they don't know.

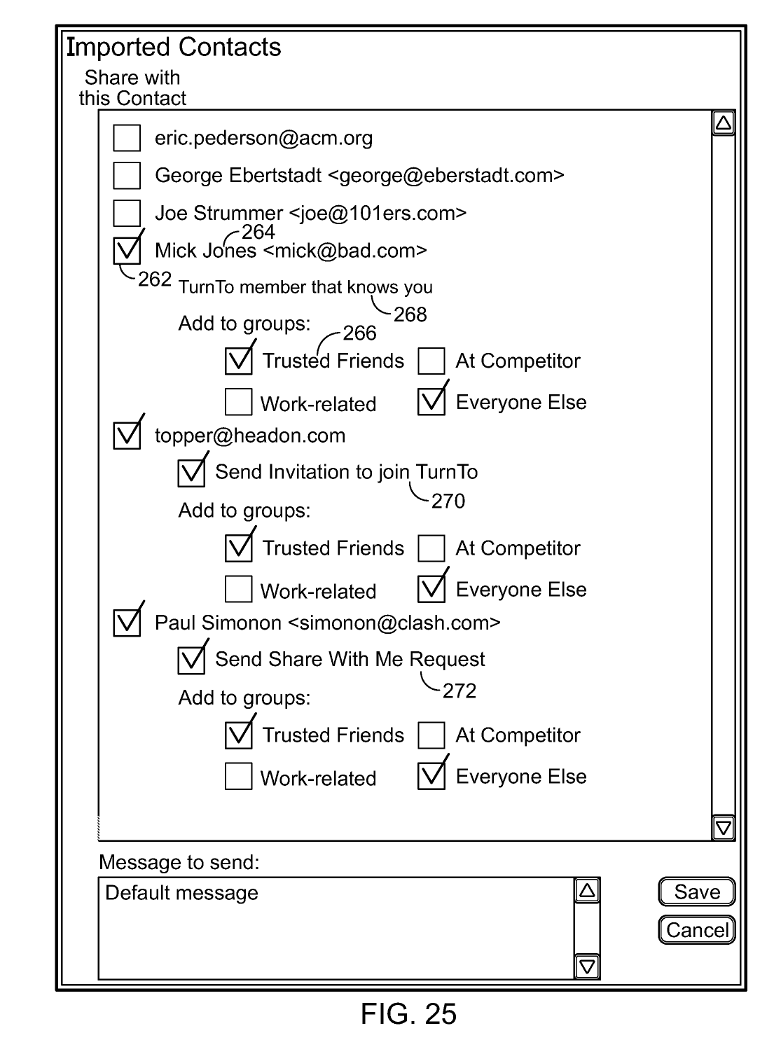

As shown in FIG. 25, an interactive screen called imported contacts shows a separation of invitation features from group membership features. Sharing can be controlled based on groups. Various options are illustrated.

The user can consent to sharing with another person by check-marking 262 the contact information 264 associated with that person. When a contact is checked, additional options are provided. The contact can be added to a group, for example, the group of trusted friends 266, by check-marking. The recipient can be added to the group without having to be invited to join the group.

By check-marking a contact, but not check-marking any group, the user can consent to sharing information with the contact without having to add the contact to a group. (This example is not illustrated in FIG. 25.)

The system reports to the user if the contact is already a member of the shared SN system 268. If not, the system permits the user to decide to send an invitation 270 or to decide to send a request for return sharing 272. In the later example shown, because the contact is already a participant in the shared SN system, no check box for an invitation to join is displayed.

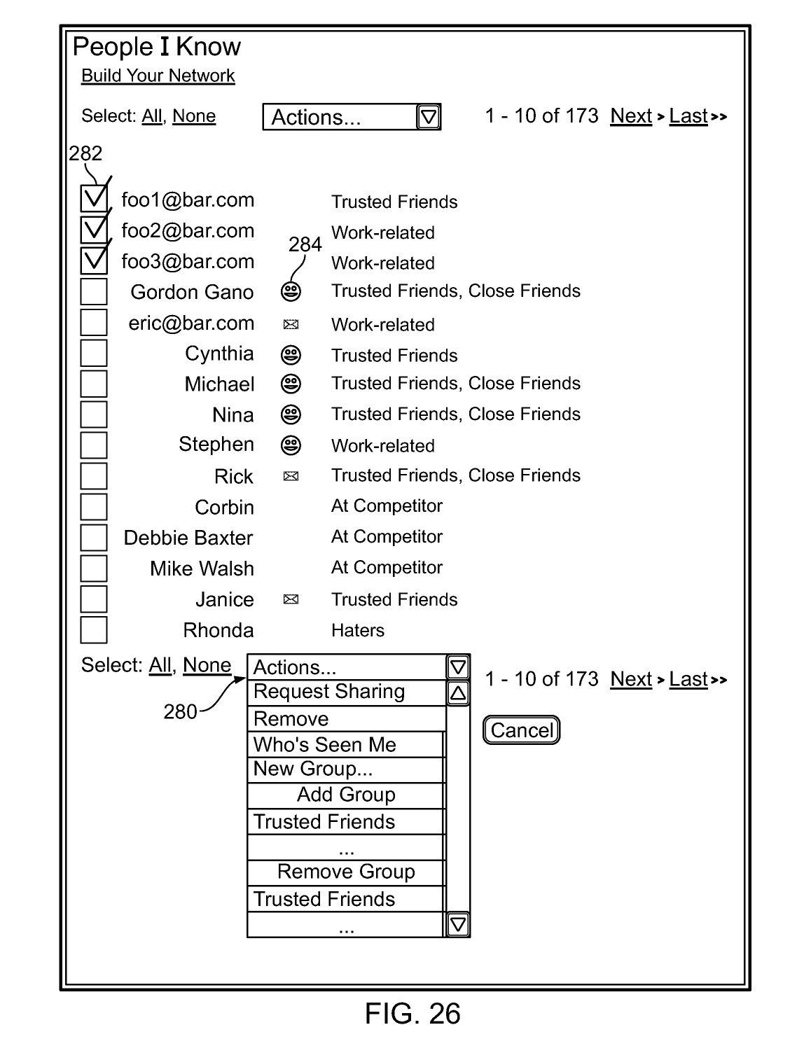

As shown in FIG. 26, the shared SN system can provide a feature to enable users to perform bulk management of contacts and connections. The actions drop-down list 280 can be invoked to select an action to be applied to all of the check-marked people 282, For example, the checked contacts can be invited, added to groups, or removed, among other functions. The actions for group management are separated from the invitation actions in the drop-down list. In the list of contacts, a smiley face 284 indicates someone who has authorized some level of sharing with the user. An envelope 286 indicates someone to whom the user has extended an invitation but who has not yet replied.

The one-way sharing mode need not be the exclusive mode of operation of the shared SN system, but could be combined for a given user or all users with two-way consent and person-of-interest modes.

As described above, in some implementations, transaction data that represents information about transactions made by users on an affiliate site can be matched, compared, or combined with who-knows-who data in a SN database. This enables the system to tell a user of an affiliate site that the user knows someone (or more than one person) who has experience with a particular activity being performed or contemplated (or with a particular entity that is the subject of an activity being performed on the affiliate site) by the user, for example, the purchase or use of a product, service, or item, and travel to a destination, among others. The system can also provide information about the nature, extent, context, purpose, and other aspects of the transactions. (Note that here, for convenience, we sometimes use the term transaction in place of the term activity, and we then intend transaction to be as broadly encompassing as the word activity as used elsewhere.)

As indicated earlier, these features can be implemented in systems in which the transaction data remains under the control of the affiliate site, or in systems in which the transaction data is sent (or copied to) the shared social network system and used there to do the matching, comparison, and combination, or in systems that combine aspects of both arrangements.

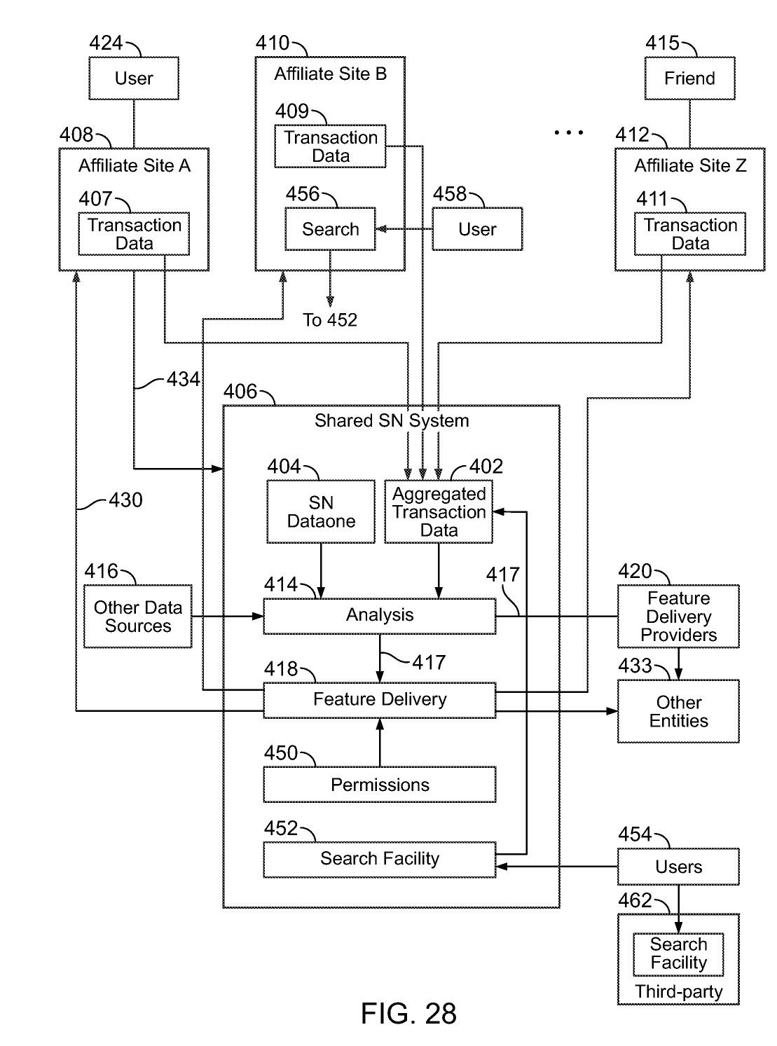

As shown in FIG. 28, significant advantages can be derived by having all of the transaction data 402 and all of the SN database information 404 (or at least enough of each of them to implement the various features discussed here) under control of one party, and in particular the shared SN system 406. Among other things, the aggregation of the transaction data 407, 409, 411, from multiple affiliate sites 408, 410, 412, makes it simpler, cheaper, and more effective to offer features that rely on the aggregation of the transaction data and the placing of those data together with the SN database.

A wide variety of analysis activities 414 can be performed on all of portions of the SN data and the aggregated transaction data and on other data available to the shared SN system (either from the affiliate sites or from other data sources 416. The results of the analysis can be provided to feature delivery systems 418 that are under the control of the shared SN system or external feature delivery providers 420. The features can then be delivered or made available or exposed to the affiliate sites or to other consumers of the features, for example, other sites, or other entities 433.

We use the term features to refer to a wide variety of (in fact, any) features, functions, and capabilities that can be implemented using the results of the analysis.

For example, when a user 424 is considering buying a certain digital camera from a site 408, the feature delivery system 414 can provide 430 to the site 408, and the site 408 can show (or report in some other way) to the user 424, that her friend 415 has bought (or in other examples, analyzed, or used, or had some other experience with) that model of digital camera from site 412. This can be done even though the purchase (or other activity) by the friend was through a different, unrelated affiliate 412 or occurred in a way that would not be captured in the transaction data of site 408. In this example, the information about the purchase by the friend, which originally was accumulated by site 412 as part of transaction data 411, has been copied as part of the aggregated transaction data 402. The connection between user 424 and friend 415 has been captured in the SN database, for example, by any of the methods described earlier, or in other ways.

When the user 424 is working on site 408 and, for example, searches for digital camera, places it in the shopping cart of the site, or on a wish list, or in some other way engages in a transaction with the camera, the site 408 provides 434 that active information to the shared SN system. The analysis can associate the transaction of friend 415 that appears in the aggregated transaction data (from site 412) with the relationship of that friend 415 with user 424 that appears in the SN database 404. The analysis provides that result 417 to the feature delivery system 418, which then passes the information to site 408. Site 408 then provides it to the user 424.

More generally, this arrangement can be applied to any user in connection with any activity or transaction being engaged in by the user (whether or not at an affiliate site), provided that (a) information about the activity or transaction is accessible electronically (not necessarily from an affiliate site), (b) social network information about the user's contacts is accessible electronically, and (c) information about an activity or transaction of at least one of the user's contacts is available electronically from a source (whether or not from an affiliate site), and is related to the user's activity or transaction. The analysis system analyzes the information and produces a result that can be used to provide any kind of feature for the user (whether or not through an affiliate site).

A wide variety of techniques can be used to manage, control, constrain, expand, and apply the capability described above. For example, the analysis system, feature delivery system, or other elements can be designed to limit the type and scope of information that may be provided to a user about the contact's activities. Because various affiliate sites may be competitors, or for other reasons, a source of transaction data that is included in the aggregated transaction data, may specify conditions under which, or the extent or kind of information about the source that may provided to the user.

For example, an affiliate site could specify which other affiliates' data they are willing to allow to be provided to users of their site. For example, Home Depot could permit a user of its site to learn that his friend had bought the same table saw from another site, but not that the purchase was made at the Lowe's site, a competitor of Home Depot. The information to control the feature delivery system to achieve this screening could be stored in a permissions database 450 at the shared SN system, based on preferences provided by the affiliate sites or other sources.

Conversely an affiliate (or other source) can state a preference whether the transaction data it provides to the aggregated data 402 may be used on sites other than its own and, if so, which sites (or other facility). In some implementations, a share-to-use policy could be implemented to require that, a facility that wants to use data from another source must to agree to permit its data to be provided to that site. In some examples, all affiliates (or sources) could be required to allow their data to be shown on all other facilities (e.g., other affiliates) as a condition of becoming an affiliate.

Additional permissions could include enabling a source (e.g., an affiliate) to specify whether it may be identified as the source of a particular transaction. Conversely, the system could require that the source be identified. For example, Best Buy could specify that other affiliates may use its transaction data as long as Best Buy is identified as the source. A comparison shopping site, e.g., Shopzilla, may be willing to agree to use the data subject to that condition, while a competitor merchant, e.g., Circuit City, may be unwilling. In some implementations, the shared SN system could specify rules regarding the identification of the source of transactions and require all affiliates to follow them as a condition of becoming an affiliate.

In addition to allowing information to be used by sources, affiliates, and other facilities in the ways described above, the shared SN system could also make the aggregated transaction data available for searching by users or other permitted parties. The searching could be done through a search facility 452 controlled by the shared SN system, or by an external entity.

Because the aggregated transaction data covers multiple sources of transactions with likely non-overlapping sets of users, information that is not otherwise easily available can be found in one place. This aggregated data can be made available for searching and other purposes to users and other parties. For example, the search facility 452 could be accessed directly by a user 454 to find friends or other contacts who have had relevant experiences with transactions or activities that are identical or similar to ones that the user is engaging in or considering.

As shown in FIG. 28, the search may be conducted at the site of the shared SN system. It could also be conducted at a third-party facility 462 such as a site (e.g., a comparison shopping site which is not a data provider but could display shared SN data along with products—e.g., Shopzilla). The shared SN system could also enable users to link from a display of trusted reference data (derived from the aggregated transaction data) directly to a location on an affiliate's site where the items can be purchased. The shared SN system may charge the affiliate site a referral fee for enabling the link.

A wide variety of searching strategies, contexts, and mechanisms could be provided. For example, the searching could be focused on specific items that are the targets of activities. A user could search based on a specific item or a category of items. For example, the user could search for friends who have experience with a Nikon D80 or with any type of Digital SLR camera. Many other variations are possible. The search results could be limited to transactions by friends, or could include friends-of-friends, or contacts who are n-degrees removed. Items that are the subject of activities could be tagged with key words which could be searched. Users could limit the searches to selected affiliates. The search could be bounded by any parameters available regarding the transaction, for example, cost, ratings, or characteristics of the item.

The search mechanism might also be used automatically by affiliates or other parties, and may be used in conjunction with a site's own search mechanism. For example, if a user on a travel site 410 searched for flights to Jamaica on the site's search facility 456, the site could also pass the search string to the central search mechanism 452 which would return a list of friends who have traveled to Jamaica, together with the travel options returned by the site's own search facility.

A wide variety of information can be included in the aggregated transaction data. All of the commercial details of a transaction might be included. In the context of a retail site, this could include detailed description and identification of an article of commerce, the quantity, date, time, and context of its purchase, identification of other related purchases, shipping, tax, promotion, and other financial information, the identity of the purchaser, and demographic and historical transaction information about the purchaser, to name a few. The aggregated transaction data can be organized as a database that allows relations that permit easy tying of information acquired from different sources. A wide variety of database schemas, database engines, and storage techniques could be used.

In general, the system described here and shown in FIG. 28 enables searching of a database of information (especially non-public) transactions (or other digital activities) assembled from multiple sources and return a list of all people who are friends (or friends-of-friends, etc.) of the user and have had experience with the transactions that match the search. (The word friend is intended broadly to include contacts of any kind.)

Also, in general, for sites of the kind that provide comparative information about products and sources of those products, the aggregated transaction data and the search facility provide the possibility of using and displaying social-network-enriched data from merchant sites to users of those sites. New comparison sites could also be created that would make similar or new uses of the aggregated transaction data. Comparison sites could make use of transaction data from one other affiliate site, or from more than one other affiliate site, which are controlled independently of each other and independently of the shared SN system.

In addition, in general, the system can provide a broad range of control by sources and users of the information concerning which data may be accessed, used, and shown and whether the source of information may or may not or must be accessible, usable, or shown.

Although, in the above discussion refers to searching, we use the term broadly to include, for example, browsing. For example, the user could browse for the item of interest through a pre-defined category tree. Enabling tree browsing, however, requires a method to reconcile dissimilar categorization schemes. One site may categorize products under the term photography, another may use the term cameras. To construct a tree would require reconciling different words used for similar categories. On the other hand, searching requires the user to try both of two similar words to find what he wants. The shortcomings of searching are more severe if the user is trying to find similar items. For example, a search for a Nikon D80 may work reasonably well, but the user may also be interested in similar products bought by his friends, for example, any other digital SLR (from any affiliate). Using a tree, though it requires a great deal of up-front work on behalf of the system, enables the system to know that a Canon EOS (bought from Circuit City) is a comparable item to a Nikon D80 (bought from Best Buy).

Tags can be used to achieve advantages of both unconstrained searching, and hunting by category. Rather than belonging to globally-defined hierarchical categories, items can be given descriptor tags, which can be anything. An affiliate that provides transaction data also provides the tags for each item as part of the feed. Because the partner wants its items to be found, they are motivated to provide a range of relevant tags. (There is the danger of an affiliate also providing irrelevant tags, which may be reduced by limiting the total number of tags that may be used.) The tags are used by the search facility to improve direct search quality, and also to improve comparable item searching: other items carrying the same tags are automatically considered to be comparable items.

Users of the shared SN system can be given control in a wide variety of ways over how the information about their transactions on sites is used.

In some implementations, the control can be characterized as offering three options: opt-in, opt-out, and conditional opt-in. The options can be selected through the website of the shared SN system or through the affiliate sites or in other ways.

The opt-in option specifies that a particular transaction will not be shared unless the user takes an action to authorize sharing. The Opt-out option specifies that a particular transaction will be shared (immediately) unless the user takes an action to prohibit it. The conditional opt-out specifies that a particular transaction will be shared once certain conditions are met (for example, the passage of time), unless the user takes an action to prohibit it. For example, a notice or request could be provided to the user indicating that a particular transaction will be shared unless the user instructs the system otherwise within 14 days after the notice is given. Other conditions could also be set.

In some implementations, each affiliate site or other facility accessible to a user could have a transaction posting policy. The policy can be one of three, corresponding to the opt-in, opt-out, and conditional opt-out described in the previous paragraph: post immediately, post after X days (where X is determined by the affiliate site), and wait for approval. By posting, we mean the shared SN site releasing the information for immediate use on other sites or through a search facility.

If the posting policy is to post immediately, the transaction information is posted as soon as it arrives at the shared SN system.

If the posting policy is to post after X days, say, the transaction information is held by the shared SN system for X days after it is received from the transaction site to give the user time to opt out. Opting out prevents the transaction information from being used by the shared SN system in an individually-identifiable way, though it may still remain in the aggregated transaction database for use in non-individually-identifiable ways. If the user takes no action to opt out during the X-day period, the transaction is automatically posted at the end of the X-day period. The X days would begin on the date when the transaction information is received by the shared SN site, not the date when the transaction took place, ensuring the user has a period of time to review if desired.

The list could show all conditional opt-in items for which the condition (e.g., the completion of the X-day timer period) had not yet occurred. In the case of timer-based conditions, the list could show the number of days remaining. Each item could have a button, for example, enabling the user to opt-out.

Under the wait-for-approval policy, the shared SN system would wait for approval (opt-in) by the user indefinitely until the user opts-in. For this purpose the transactions could be included on a list reported to the user each week together with a button for each entry enabling the user to opt in.

The default posting policy for an affiliate site or other facility could be set by the site or facility. The user could then be permitted to personalize the posting policy for her own transactions on a site by site basis. Users of sites are able to view the posting policy at any time and therefore are presumed to know and accept the policy.

For purposes of controlling dissemination of a user's transaction information, each transaction may be in one of three posting states: posting, pending, or removed.

A posted transaction is one for which the information is available for display to contacts of the user at any site or facility being used by the contacts. The user can be enabled to change the state of a posted transaction to “removed” at any time, through the site of the shared SN system or the affiliate site, or in other ways.

A pending transaction may have an auto-post date or no date. A pending transaction may not be disseminated to contacts of the user. However, the information for each pending transaction may be used by the shared SN system, and other parties to whom it is given, provided that it is used in non-individually-identifiable ways (for example, for analytics or ad targeting). The state of a pending transaction may be changed to posted or removed by the user in the same ways mentioned for posted transactions.

Information about a transaction that is in the removed state may not be disseminated to contacts of the user, but it may be used in non-individually-identifiable ways. The state of a removed transaction may be changed to posted by the user, or it may be deleted, in which case it is removed completely from the system. Enabling a user to delete is desirable, but deleting reduces the completeness of the aggregated transaction data and prevents the user from changing his mind later if he regrets the deletion. The shared SN system could be configured so that state information about transactions is maintained if and when transactions are otherwise refreshed from the sources of the transactions.

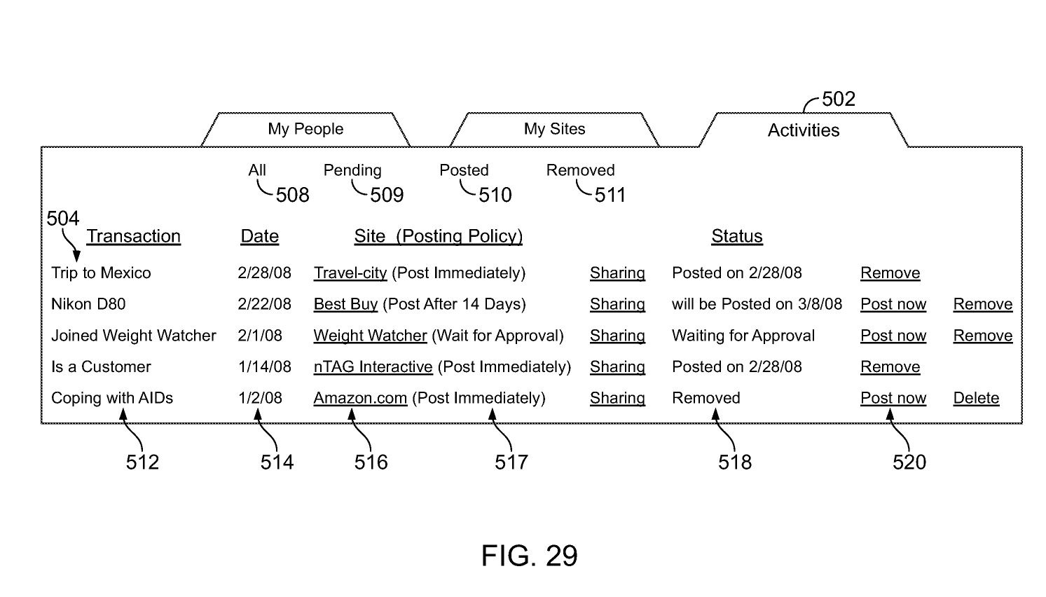

As shown in FIG. 29, the user interface with respect to the opt-in and opt-out features could include an Activities tab 502. In the example shown in FIG. 29, the user interface displays a reverse chronological list 504 of all transactions across all sites for ease of management by the user. The transactions also can be organized by site (we sometimes use the word site to refer broadly to online facilities of any kind). In that case, the transactions for each site would be listed under a heading for that site.

The interface can provide filtering functions 506, 508, 510, and 511 that allow the user to filter transactions by status, for example, to show all transactions, only pending transactions, only posted transactions, and only removed transactions.

For each transaction, the list includes a transaction column 512 to identify the transaction, a date column 514, (which could be the date of the transaction, or the date when the transaction is sent to the shared SN site, or both). The entries can be sorted based on the dates.

A site column 516 identifies the site which is the source of each transaction. Each site name is clickable and takes the user to a page for managing, sharing, and otherwise working with transactions and preferences for that site. The posting policy for the site 517 is also shown. An icon could also show the posting policy when a mouse-over or click invokes the icon.

A status column 518 shows the state of each transaction and includes appropriate action buttons 520

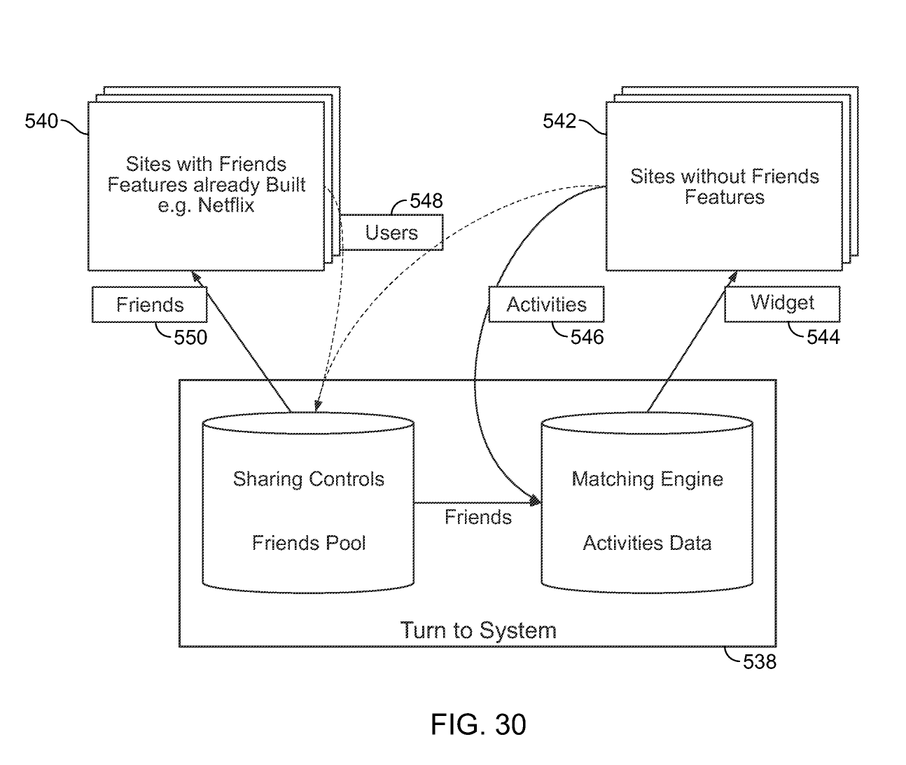

As shown in FIG. 30, the TurnTo system 538 can provide outsourced social graph management for sites 540 that have “friends” features and want to affiliate with the TurnTo system to increase the number of people signing up for the “friends” feature. The TurnTo system can also provide a complete “Trusted Reference Application” for sites 542 that do not have “friends” features. In the latter case, the system provides a widget 544 for inclusion on site 542 and receives activity/transaction information 546 back. For the purpose of registering users to make use of the friends feature, information about the users 548 is also sent to the system from either type of site. For sites with friends features, friends information 550 can be sent back from the system to the sites. For both purposes, the social network engine 552 is used, while (in some cases) only the database of transactions/activities 554 is used for sites without friends features.

1-32. (canceled)

33. A computer-implemented method comprising
providing, to a user of a site, access to information associated with a person who has entered, on a shared social network (SN) system controlled independently of the site, a consent to permit information of the person to be accessed by the user at the site, the information being displayed to the user of the site only in accordance with the consent, the consent being effective without requiring any action by the user of the site.

34. The method of claim 33 in which the user of the site has access to the information without necessarily being aware of the existence of the consent.

35. The method of claim 33 in which the user of the site is a participant of the shared SN system.

36. The method of claim 33 in which the consent is conditioned on a rule expressed by the person who has entered the consent.

37. The method of claim 36 in which the rule determines on which sites the consent is effective.

38. The method of claim 36 in which the rule determines when the consent is effective.

39. The method of claim 36 in which the rule determines the scope of the information for which the consent is effective.

40. The method of claim 36 in which the rule determines the context in which the consent is effective.

41. The method of claim 36 also including before the user is given access, requiring the user to become a participant in the shared SN system.

42. The method of claim 33 in which the information is non-public information of the person.

43. The method of claim 33 in which the information comprises an identity of the person.

44. The method of claim 33 in which a volume of users with respect to whom the person is permitted to enter consents is constrained.

45. The method of claim 33 also including enabling the user to indicate, in advance, whether he is willing to be given access to the information.

46. The method of claim 33 in which the consent comprises a one-way connection in which information can flow in one direction to the user but not in another direction to the person.

47. The method of claim 33 in which consent flows from the person to the shared SN system and the information flows from the site to the user based on an authorization provided from the shared SN system to the site.

48. The method of claim 33 in which the user of the site is not a participant of the shared SN system.

49. The method of claim 33 in which the information is displayed to the user of the site based on an activity of the user on the site, the activity being related to the information.

50. A computer-implemented method comprising
enabling a participant in a shared social network (SN) system to enter a consent to permit information of the participant to be accessed at a site that is controlled independently of the shared SN system by a user of the site, the consent being effective without requiring any action by the user of the site.

51. The method of claim 50 in which the user of the site has access to the information without being aware of the existence of the consent.

52. The method of claim 50 in which the consent is conditioned on a rule expressed by the participant.

53. The method of claim 52 in which the rule determines on which sites the consent is effective.

54. The method of claim 52 in which the rule determines when the consent is effective.

55. The method of claim 52 in which the rule determines the scope of the information for which the consent is effective.

56. The method of claim 50 in which the rule determines the context in which the consent is effective.

57. The method of claim 50 also including
before the user is given access, requiring the user to become a participant in the shared SN system.

58. The method of claim 50 in which the information comprises non-public information of the participant.

59. The method of claim 50 in which the information comprises an identity of the participant.

60. The method of claim 50 in which the consent comprises a one-way connection in which information can flow in one direction to the user but not in another direction to the participant.

61. The method of claim 50 in which consent flows from the participant to the shared SN system and the information flows from the site to the user based on an authorization provided from the shared SN system to the site.

62. The method of claim 50 in which the user of the site is not a participant of the shared SN system.

63. The method of claim 50 in which the information is displayed to the user of the site based on an activity of the user on the site, the activity being related to the information.
